(19) United States
(12) Patent Application Publication
(10) Pub. No.: US 2022/0326546 A1
(43) Pub. Date: Oct. 13, 2022

(54) DUAL CONFIGURATION CONTACT LENSES

(71) Applicant: Pres-By Vision Ltd., Tel Aviv (IL)

(72) Inventors: Yair ALSTER, Tel Aviv-Yafo (IL); Omer RAFAELI, Udim (IL); Matt CLARKE, San Carlos, CA (US); Nir BETSER, Tel Aviv-Yafo (IL); Barak AZMON, Tel Aviv-Yafo (IL)

(21) Appl. No.: 17/838,019

(22) Filed: Jun. 10, 2022

Related U.S. Application Data
(63) Continuation of application No. PCT/IB2020/001050, filed on Dec. 17, 2020.
(60) Provisional application No. 62/955,610, filed on Dec. 31, 2019.

(51) Int. Cl. G02C 7/04

(52) U.S. Cl. CPC G02C 7/047; G02C 7/044; G02C 7/028

(57) ABSTRACT

A contact lens having more than one configuration is disclosed herein. The optical power of the contact lens may be dynamically changed through the different configurations of the contact lens. The different configurations may be actuated using a valve. Also disclosed herein is a contact lens comprising a dimension, which contact lens is configured to have the dimension change non-linearly as a function of a pressure applied to the contact lens.

### CROSS-REFERENCE

This application is a continuation of International Patent Application No. PCT/IB2020/001050, filed Dec. 17, 2020, which claims the benefit of U.S. Provisional Patent Application No. 62/955,610, filed on Dec. 31, 2019, which is incorporated by reference herein in its entirety.

### BACKGROUND

Typical vision deficiencies such as myopia (nearsightedness), hyperopia (farsightedness), and presbyopia (loss of accommodation and subsequent loss of near and intermediate vision) may be readily correctable using eyeglasses. However, some individuals may prefer contact lenses for vision correction.

Contact lens wearers who become presbyopic with age may require additional corrective lenses to allow each of near, intermediate, and distance vision. Multifocal lenses, which can simultaneously focus light from a range of distances via several focal regions, and bifocal lenses can be used to address presbyopia. One type of multifocal lens, a translating contact lens, may be configured for moving (translating) anywhere from 1 mm to 6 mm over the surface of the cornea but can be less stable than standard contact lenses and may cause user discomfort due to, for example, lid impingement, inflammation, and trauma to the cornea and lower lid. Thus, new approaches for addressing presbyopia are needed.

### SUMMARY

Recognized herein is a need for alternative contact lenses for correcting vision, e.g., for presbyopic subjects.

In an aspect, disclosed herein is a contact lens, comprising: an anterior surface; a posterior surface disposed at a dimension from a cornea of a subject when the contact lens is applied to the cornea; wherein the contact lens is configured to have the dimension change non-linearly as a function of a pressure applied to the posterior surface.

In some embodiments, the posterior surface comprises (i) a central portion comprising a first posterior base curve and (ii) a peripheral portion comprising a second posterior base curve, wherein when the posterior surface is subjected to the pressure, the first posterior base curve is substantially the same as the second posterior base curve. In some embodiments, in the absence of the pressure, the first posterior base curve is steeper than the second posterior base curve. In some embodiments, the first posterior base curve or the second posterior base curve has a radius of curvature of from about 1 mm to about 10 mm. In some embodiments, the contact lens further comprises at least one fluid conduit in fluid communication with the anterior surface, an edge of the contact lens, or the peripheral portion of the posterior surface. In some embodiments, when applied to the cornea, the first posterior base curve diverges from a curvature of the cornea in the absence of the pressure, and wherein, in the presence of fluid, a tear chamber forms between the cornea and the first posterior base curve. In some embodiments, the central portion has a diameter of about 2 millimeters (mm) to about 8 mm. In some embodiments, the central portion has a thickness of about 50 micrometers (μm) to about 500 μm. In some embodiments, the pressure is between 200 Pascals (Pa) and 20,000 Pa. In some embodiments, the pressure sufficient to have the dimension change non-linearly is based on at least one or more parameters of the contact lens selected from the group consisting of: a thickness, a modulus, a diameter of a central portion of the surface, and a sagittal height. In some embodiments, the dimension is a sagittal height. In some embodiments, the sagittal height is between 0-100 μm. In some embodiments, the dimension is a gap height between the posterior surface and a surface of the cornea. In some embodiments, the dimension is a difference in curvature between the posterior surface and a surface of the cornea. In some embodiments, the change in the dimension results in a change in optical power. In some embodiments, the change in optical power is between 0.25 diopters to 10 diopters. In some embodiments, the change in optical power is a decrease in optical power. In some embodiments, the change in optical power is a flattening of the anterior surface and the posterior surface. In some embodiments, the anterior surface or the posterior surface changes curvature in response to the pressure in a non-linear manner. In some embodiments, the change in optical power is an increase in optical power. In some embodiments, the change in optical power is a bulging of the anterior surface and/or the posterior surface. In some embodiments, the non-linear change is multiphasic or continuous. In some embodiments, the non-linear change is defined by a non-linear curve having at least two segments, the at least two segments comprising a first steep segment where the dimension changes in response to the applied pressure at a first rate and a second slight segment where the dimension changes in response to the pressure at a second rate less than the first rate. In some embodiments, the non-linear curve further comprises at least one additional gradual segment where the dimension changes in response to the pressure at a rate between the first and second rates. In some embodiments, wherein the contact lens comprises silicone, a hydrogel, or a silicone hydrogel. In some embodiments, the contact lens has a Young's modulus from about 0.1 mega pascals (MPa) to about 1000 MPa.

In another aspect, disclosed herein is a contact lens, the contact lens comprising: a central portion having a first configuration and a second configuration when applied to a cornea of a subject, wherein in the first configuration, a posterior surface of the central portion is disposed at a first dimension from the cornea of the subject resulting in a first optical power, wherein in the second configuration, the posterior surface of the central portion is disposed at a second dimension from the cornea resulting in a second optical power, wherein the first dimension is different than the second dimension; and a valve coupled to the central portion and configured to actuate the central portion from the first configuration to the second configuration thereby adjusting an optical power of the contact lens.

In some embodiments, a difference in the first optical power and the second optical power is between 0.25 diopters to 10 diopters. In some embodiments, the difference in the first optical power and the second optical power is a decrease in optical power. In some embodiments, the difference in the first optical power and the second optical power is a flattening of an anterior surface of the contact lens. In some embodiments, the difference in the first optical power and the second optical power is an increase in optical power. In some embodiments, the difference in the first optical power and the second optical power is a bulging of an anterior surface of the contact lens. In some embodiments, an anterior surface of the central portion of the contact lens changes curvature in response to pressure in a non-linear manner. In some embodiments, the first dimension or the second dimension is a sagittal height. In some embodiments, the first dimension or the second dimension is a gap height between the posterior surface and a surface of the cornea. In some embodiments, the first dimension or the second dimension is a radius of curvature between the posterior surface and a surface of the cornea. In some embodiments, the radius of curvature is from about 1 mm to about 10 mm. In some embodiments, in the second configuration, the valve is in contact with a tear meniscus of the cornea.

In some embodiments, the central portion comprises a first posterior base curve and wherein the contact lens further comprises a peripheral portion adjacent to the central portion, wherein the peripheral portion comprises a second posterior base curve. In some embodiments, in the first configuration, the first posterior base curve is substantially the same as the second posterior base curve. In some embodiments, in the second configuration, the central portion is disposed at a sagittal height of from about 5 micrometers (μm) to about 100 μm from the second posterior base curve. In some embodiments, the contact lens further comprises a peripheral portion adjacent to the central portion. In some embodiments, the contact lens further comprises a fluid conduit in fluid communication with the valve and an anterior surface of the peripheral portion, wherein the fluid conduit is coupled to the posterior surface of the central portion. In some embodiments, the valve is disposed at a cross section of the fluid conduit. In some embodiments, wherein upon contacting the valve with a first volume of tear fluid, the valve is configured to stay closed and when contacting the valve with a second volume of tear fluid, the valve is configured to open and allow a third volume of tear fluid to enter the central portion via the fluid conduit in order to actuate the central portion from the first configuration to the second configuration. In some embodiments, the valve is positioned to contact the second volume of tear fluid when the subject looking in a downward gaze. In some embodiments, the valve is positioned to contact the first volume of tear fluid when the subject looking in a forward gaze. In some embodiments, following actuation, the first configuration converts to the second configuration in less than 3 seconds. In some embodiments, following actuation, the first configuration converts to the second configuration in less than 1 second. In some embodiments, the third volume of tear fluid is configured to be expelled when the patient blinks in order to return the central position to the first configuration. In some embodiments, the contact lens is configured to be maintained in the first configuration when the subject looks in a forward gaze. In some embodiments, the valve, when exposed to air, is configured to maintain the first configuration. In some embodiments, the valve has a valve-opening pressure between 200 Pascals (Pa) and 20,000 Pa. In some embodiments, the central portion comprises a first posterior base curve. In some embodiments, the contact lens further comprises, a peripheral portion coupled to the central portion, wherein the peripheral portion comprises a second posterior base curve. In some embodiments, in the first configuration, the first posterior base curve is substantially the same as the second posterior base curve. In some embodiments, in the second configuration, the first posterior base curve is steeper than the second posterior base curve. In some embodiments, in the second configuration, the posterior surface of the central portion has a radius of curvature diverging from a curvature of the cornea. In some embodiments, the contact lens comprises silicone, a hydrogel, or a silicone hydrogel. In some embodiments, the central portion has a diameter of about 2 millimeters (mm) to about 8 mm. In some embodiments, the central portion has a thickness of about 50 micrometers (μm) to about 500 μm. In some embodiments, the contact lens has a Young's modulus from about 0.1 MPa to about 1000 MPa.

In yet another aspect, disclosed herein is a method for dynamically changing an optical power of a contact lens, the method comprising: (a) providing a contact lens comprising a valve coupled to a central portion, the central portion having an optical power, (b) providing a fluid volume sufficient to overcome a burst pressure threshold of the valve, thereby generating a change in a radius of curvature of the central portion of the contact lens and dynamically changing the optical power.

In some embodiments, the change in the radius of curvature results in a change in optical power between 0.25 diopters to 10 diopters. In some embodiments, the change in the radius of curvature ranges from about 1 mm to about 10 mm. In some embodiments, the change in optical power is between 0.25 diopters to 10 diopters. In some embodiments, the change in optical power is a decrease in optical power. In some embodiments, the change in optical power in an increase in optical power. In some embodiments, the change in optical power is a change in shape of an anterior surface of the contact lens. In some embodiments, an anterior surface of the contact lens changes curvature in response to pressure in a non-linear manner. In some embodiments, the fluid volume comprises a volume of tear fluid. In some embodiments, the fluid volume of tear fluid is provided when a subject looks down. In some embodiments, the contact lens comprises (i) a central portion comprising a first posterior base curve and (ii) a peripheral portion comprising a second posterior base curve, wherein prior to providing of the fluid volume, the first posterior base curve is substantially the same as the second posterior base curve. In some embodiments, following applying of the fluid volume, the first posterior base curve is steeper than the second posterior base curve. In some embodiments, the contact lens further comprises at least one fenestration that connects a fluid conduit in the peripheral portion to an anterior surface of the surface. In some embodiments, following the change, the central portion is disposed 5 to 100 micrometers (μm) from the second posterior base curve. In some embodiments, the central portion has a diameter of about 2 millimeters (mm) to about 8 mm. In some embodiments, the central portion has a thickness of about 50 micrometers (μm) to about 500 μm. In some embodiments, the change in the radius of curvature results in a change in a sagittal height of the central portion. In some embodiments, prior to (b), the central portion is in contact with a tear film of the cornea. In some embodiments, the valve comprises a capillary valve. In some embodiments, the contact lens comprises a groove coupled to the valve. In some embodiments, in (b), the valve allows a second volume of tear fluid to enter the groove thereby causing the change in the radius of curvature. In some embodiments, the providing of the volume of tear fluid comprises a subject looking in a downward gaze. In some embodiments, upon blinking of the subject, the volume of tear fluid is expelled from the contact lens, thereby returning the central position to the first configuration. In some embodiments, when the subject looks in a forward gaze, the first configuration is maintained. In some embodiments, the change in the radius of curvature occurs in less than 3 seconds. In some embodiments, the change occurs in less than 1 second. In some embodiments, the contact lens comprises silicone, a hydrogel or a silicone hydrogel. In some embodiments, the contact lens has a Young's modulus from about 0.1 MPa to about 1000 MPa.

Another aspect of the present disclosure provides a non-transitory computer readable medium comprising machine executable code that, upon execution by one or more computer processors, implements any of the methods above or elsewhere herein.

Another aspect of the present disclosure provides a system comprising one or more computer processors and computer memory coupled thereto. The computer memory comprises machine executable code that, upon execution by the one or more computer processors, implements any of the methods above or elsewhere herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIG. 1 schematically shows a cross-sectional view of a contact lens provided by the present disclosure.

FIGS. 2A-2B schematically show valves provided by the present disclosure.

FIGS. 3A-3C shows a schematic of parameters useful in calculating capillary forces.

FIG. 3D schematically shows a cross-sectional view of a capillary meniscus formed within a fenestration of the contact lens.

FIGS. 4A-4B schematically show a diagram of fluid transport in an example of a contact lens provided by the present disclosure.

FIGS. 5A-5B schematically show a diagram of fluid transport in another example of a contact lens provided by the present disclosure.

FIGS. 6A-6B schematically show top-down and side views of a contact lens having an interface between the central and peripheral portions and fenestrations around the circumference of the interface between the central and peripheral portions.

FIGS. 7A-7D schematically show a top-down view of a contact lens having an interface between the central and peripheral portions, and top-down and side views of the interface between the central and peripheral portions.

FIGS. 8A-8C schematically show views of a contact lens having fenestrations in the interface between the central and peripheral portions.

FIGS. 9A-9I schematically show views of a contact lens having fenestrations in the interface between the central and peripheral portions.

FIG. 10 schematically shows a view of the posterior surface of an example of a contact lens provided by the present disclosure with fluid conduits extending from the peripheral posterior surface to the central portion and with fenestrations connected to each of the fluid conduits.

FIG. 11 schematically shows a view of the anterior surface of the contact lens shown in FIG. 10.

FIG. 12 schematically shows a view of the posterior surface of an example of a contact lens provided by the present disclosure.

FIGS. 13A-13C show examples of a contact lens provided by the present disclosure.

FIGS. 13A and 13B schematically show a cross-sectional view and a view of the posterior surface, respectively, of an example of a contact lens provided by the present disclosure. FIG. 13C shows an image of the contact lens of FIGS. 13A-13B on an eye of a patient.

FIG. 14 shows a slit lamp bio-microscope image of a contact lens having eight (8) fenestrations on an eye of a patient

FIGS. 15A-15H schematically show views of a contact lens having depressions and fenestrations within the depressions disposed in the second peripheral portion near the interface between the central and peripheral portions.

FIGS. 16A-16C schematically show perspective views of the anterior surface (FIG. 16A), the posterior surface (FIG. 16B), and a cross-sectional view (FIG. 16C) of an example of a contact lens having an elongated anterior fluid conduit configured to fluidly couple with a tear fluid volume and a fenestration and posterior fluid conduit for transporting tear fluid to the optical tear volume.

FIGS. 17A-17D schematically show views of the anterior surface (FIGS. 17A and 17B) and the posterior surface (FIGS. 17C and 17D) of examples of contact lenses having a plurality of fenestrations disposed at different radial distances from the optical center and posterior fluid conduits for transporting tear fluid from a tear meniscus to the optical tear volume.

FIGS. 18A-18C schematically show perspective views of the anterior surface (FIG. 18A), the posterior surface (FIG. 18B), and a cross-sectional view (FIG. 18C) of an example of a contact lens having an anterior fluid conduit configured to fluidly couple with a tear meniscus and with a fenestration and posterior fluid conduit for transporting tear fluid to the optical tear volume.

FIGS. 19A-19C schematically show perspective views of the anterior surface (FIG. 19A), the posterior surface (FIG. 19B), and a cross-sectional view (FIG. 19C) of an example of a contact lens having anterior fluid conduits configured to fluidly couple with a tear fluid volume and fenestrations and posterior fluid conduits for transporting tear fluid to the optical tear volume.

FIG. 20 schematically shows a diagram of a computer system that is programmed or otherwise configured to implement methods provided herein.

FIGS. 21A-21B show plots of sagittal heights as a function of pressure. FIG. 21A shows a plot of the relationship between applied pressures and sagittal heights from 0 mm to 0.1 mm in a contact lens of the present disclosure. FIG. 21B shows a plot of the relationship of flattening pressures and sagittal heights from 0 mm to 0.01 mm in a contact lens of the present disclosure.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

Where values are described as ranges, it will be understood that such disclosure includes the disclosure of all possible sub-ranges within such ranges, as well as specific numerical values that fall within such ranges irrespective of whether a specific numerical value or specific sub-range is expressly stated.

As used herein, the term “posterior” describes features facing toward the eye and the term “anterior” describes features facing away from the eye when worn by a subject. A posterior surface of a dynamic contact lens or portion thereof refers to a surface that is near to or faces the cornea during wear by a subject. The anterior surface of a dynamic contact lens or portion thereof refers to a surface that is away from or faces away from the cornea during wear by a subject.

As used herein, the term “subject” generally refers to an animal, such as a mammal (e.g., human), reptile, or avian (e.g., bird), porcine (e.g., a pig) or other animal. For example, the subject can be a vertebrate, a mammal, a rodent (e.g., a mouse), a primate, a simian or a human. A subject can be a healthy or asymptomatic individual, an individual that has or is suspected of having a disease or condition or a pre-disposition to the disease or condition, and/or an individual that is in need of therapy or suspected of needing therapy. A subject can be a patient. A subject can be a user.

As used herein, the term “substantially” refers to ±10% of a value such as a dimension.

As used herein, the term “modulus” of refers to the Young's modulus of a material. The Young's modulus can be determined, for example, according to the method described by Jones et al., Optometry and Vision Science, 89, 10, 1466-1476, 2017, which is incorporated herein by reference in its entirety for all purposes.

The optical power of the cornea in diopters (D) can be related to the radius of curvature R by the formula D=(1.376−1)/R, where 1.376 corresponds to the index of refraction of the cornea and R corresponds to the radius of curvature of the anterior surface of the cornea. The curvature of the cornea is inversely related to the radius of curvature R such that as the radius of curvature increases the curvature of the cornea decreases, and such that as the radius of curvature decreases the curvature of the cornea increases.

Contact Lens with Dual Configurations

In an aspect, provided herein is a contact lens comprising a dimension that changes non-linearly as a function of a force or pressure applied to the contact lens, which change in dimension results in a change of optical power of the contact lens. The change of optical power of the contact lens can occur while a subject is wearing the contact lens. The contact lens may comprise an anterior surface and a posterior surface that is disposed at a dimension from a cornea of a subject when the contact lens is applied to the cornea. The contact lens may be configured to have the dimension change non-linearly as a function of a pressure applied to the posterior surface.

The contact lens may comprise an optical portion (e.g., in the center, in a central region or portion). The contact lens may be fabricated such that the optical or central region can transition between two or more quasi-stable configurations, where each of the two or more quasi-stable configurations provides a different optical power. The difference in optical power between the two quasi-stable configurations can be determined by the difference in the refractive power of the anterior surface of the optical or central portion of the contact lens. For example, in a first configuration, the optical or central portion may be disposed at a first dimension from the cornea (e.g., the anterior surface of the cornea), resulting in a first optical power. In a second configuration, the optical or central portion may be disposed at a second dimension from the cornea and result in a second optical power. The first optical power may differ from the second optical power. In some instances, in the first configuration, the contact lens (e.g., the optical or central portion) may be substantially conforming with the cornea, whereas in the second configuration, the contact lens (e.g., the optical or central portion) may bulge away or be substantially non-conforming with the cornea.

The contact lens may also comprise a peripheral portion coupled to the optical or central portion. The peripheral portion may span radially outward from the optical or central portion. In some cases, the posterior surface of the contact lens comprises the posterior surface of the optical portion and the posterior surface of the peripheral portion.

The optical or central portion may have a first posterior base curve. The contact lens may also comprise a peripheral portion that has a second posterior base curve. The peripheral portion may be coupled to the central portion. The contact lens may be configured such that, when the posterior surface is subjected to a pressure (e.g., in the first configuration), the first posterior base curve may be substantially the same as the second posterior base curve. Alternatively or in addition, the contact lens may be configured such that in the absence of the pressure, (e.g., in the second configuration) the first posterior base curve is steeper than the second posterior base curve.

The first posterior base curve or the second posterior base curve may have a radius of curvature within a range. The first posterior base curve or the second posterior base curve may have a radius of curvature of at most about 10 mm, 9.5 mm, 9 mm, 8.5 mm, 8 mm, 7.5 mm, 7 mm, 6.5 mm, 6 mm, 5.5 mm, 5 mm, 4.5 mm, 4 mm, 3.5 mm, 3 mm, 2.5 mm, 2 mm, 1.5 mm, 1 mm, or less. The first posterior base curve or the second posterior base curve may have a radius of curvature of at least about 1 mm, 1.5 mm, 2 mm, 2.5 mm, 3 mm, 3.5 mm, 4 mm, 4.5 mm, 5 mm, 5.5 mm, 6 mm, 6.5 mm, 7 mm, 7.5 mm, 8 mm, 8.5 mm, 9 mm, 9.5 mm, 10 mm, or more. The first posterior base curve or the second posterior base curve may have a radius of curvature that is within a range defined by any two of the preceding values. The optical posterior surface can have a radius of curvature, for example, from 3 mm to 7.5 mm, from 3 mm to 7 mm, from 3.5 mm to 6.5 mm, or from 4 mm to 6 mm.

When applied to the cornea of a subject, the first posterior base curve may diverge from the curvature of the cornea in the absence of an applied pressure. For example, in the second configuration, the optical or central portion may be disposed at a second dimension from the cornea, such that the radius or curvature of the first posterior curve is substantially different than the curvature of the cornea. Upon application of a pressure, the contact lens may return to the first configuration, and the first posterior base curve may be substantially the same as the second posterior base curve.

The change in pressure or removal of an applied pressure may be initiated by introduction of a fluid (e.g., liquid) volume to a portion of the contact lens. For example, in the presence of a volume of fluid (e.g., tear fluid), a chamber comprising the fluid volume may form between the cornea and the first posterior base curve. The fluid volume may come from the subject. For instance, the fluid volume may comprise tear fluid from a subject's tear reservoir or tear meniscus. The tear volume may come from between the posterior surface of the optical or central portion of the lens and the anterior surface of the cornea when the dynamic contact lens is worn on the eye of a patient. The tear volume can be a lenticular tear volume or tear fluid chamber, or in some configurations (e.g., the first configuration), the tear volume may be a part of or comprise a tear film having a substantially constant thickness across the optical or central portion. The optical lens system can include the optical or central portion of the contact lens, the tear film, and the tear fluid chamber, if present. For example, in the second configuration, in which the contact lens is substantially non-conforming to the cornea, a tear chamber may be disposed between the anterior surface of the cornea and the posterior surface of the contact lens or portion thereof (e.g., optical or central portion). The tear chamber, in addition to the other optical components of the contact lens, may provide for an optical power. As described herein, the contact lens may be configured to actuate between one or more configurations (e.g., a first configuration and a second configuration).

A minimum volume of fluid or liquid may be required to actuate the change in configuration of the contact lens. For instance, the contact lens may be configured to actuate from the first configuration to the second configuration when the contact lens is placed in contact with a tear film that has a thickness of at least about 5 μm, at least about 6 μm, at least about 7 μm, at least about 8 μm, at least about 9 μm, at least about 10 μm, at least about 11 μm, at least about 12 μm, at least about 13 μm, at least about 14 μm, at least about 15 μm, at least about 16 μm, at least about 17 μm, at least about 18 μm, at least about 19 μm, at least about 20 μm, or more. In such cases, when the contact lens is in contact with a first volume of tear film that is below the minimum volume of fluid or liquid required to actuate the change, the contact lens may remain in the first configuration. However, upon contacting the contact lens with a volume of tear fluid that is greater than the minimum volume of fluid or liquid required to actuate the change, the contact lens may transition to the second configuration. In such cases, a third volume of tear fluid may enter a fluid conduit of the contact lens and be directed (e.g., via capillary forces) to the optical or central portion, thereby changing the optical power of the contact lens.

The contact lens may comprise at least one fluid conduit that is in fluid communication with the anterior surface of the contact lens, an edge of the contact lens, or the peripheral portion of the posterior surface. In some cases, the fluid conduit is in fluid communication with the anterior surface and the anterior environment via a fenestration. The fluid conduit may fluidically connect the anterior surface to a portion of the posterior surface of the peripheral portion. The posterior surface of the peripheral portion may also be fluidically connected, via the fluid conduit, to a portion of the posterior surface of the optical or central portion. In some cases, the fluid conduit may fluidically connect the anterior surface to an edge of the contact lens (e.g., the edge of the peripheral portion). The edge of the contact lens also be fluidically connected, via the fluid conduit, to a portion of the posterior surface of the optical or central portion.

The contact lens may comprise a valve, such as a capillary valve. The valve may be disposed at a cross-section of the fluid conduit. The valve may be coupled fluidically to the optical or central portion of the contact lens (e.g., via the fluid conduit) and may be configured to actuate the central portion, from the first configuration to the second configuration, thereby dynamically adjusting the optical power of the contact lens. In some instances, the valve may be in contact with a tear film. In some instances, actuation of the optical or central portion of the contact lens from the first configuration to the second configuration may comprise providing a tear volume sufficient to overcome the valve burst pressures. For example, the contact lens may be configured to remain in a first configuration upon application of a pressure (e.g., via the subject blinking or squinting). Upon introduction of a sufficient tear volume to the contact lens (e.g., via the subject looking in a downward gaze, thereby providing a tear volume from the tear meniscus to the contact lens), the tear fluid may travel in the fluid conduit (e.g., via capillary flow) to the valve, which may be disposed at a cross-section of the fluid conduit. In some instances, the capillary flow may provide sufficient pressure for the tear fluid volume to cross the valve (e.g., overcome the capillary burst pressure). Exceeding the valve burst pressure may result in a change in pressure applied to the posterior surface of the contact lens. For instance, fluid introduction through the fluid conduit and valve may remove a pressure gradient that maintains the contact lens in the first configuration, thereby actuating the transition of the optical or central portion of the lens to the second configuration.

As described herein, a minimum volume of fluid or liquid may be required to actuate the change in configuration of the contact lens. For instance, the contact lens may be configured to actuate from the first configuration to the second configuration when the contact lens is placed in contact with a tear film that has a thickness of at least about 5 μm, at least about 6 μm, at least about 7 μm, at least about 8 μm, at least about 9 μm, at least about 10 μm, at least about 11 μm, at least about 12 μm, at least about 13 μm, at least about 14 μm, at least about 15 μm, at least about 16 μm, at least about 17 μm, at least about 18 μm, at least about 19 μm, at least about 20 μm, or more. In such cases, when the contact lens is in contact with a first volume of tear film that is below the minimum volume of fluid or liquid required to actuate the change, the valve of the contact lens may remain closed, thereby maintaining the contact lens in the first configuration. However, upon contacting the contact lens with a second volume of tear fluid, where the second volume of tear fluid is greater than or equal to the minimum volume of fluid or liquid required to actuate the change, the valve may open and allow a third volume of tear fluid to enter the contact lens (e.g., via a fluid conduit), thereby initiating the transition of the contact lens from the first configuration to the second configuration. In such cases, the third volume of tear fluid may enter a fluid conduit of the contact lens and be directed (e.g., via capillary forces) to the optical or central portion, thereby changing the optical power of the contact lens.

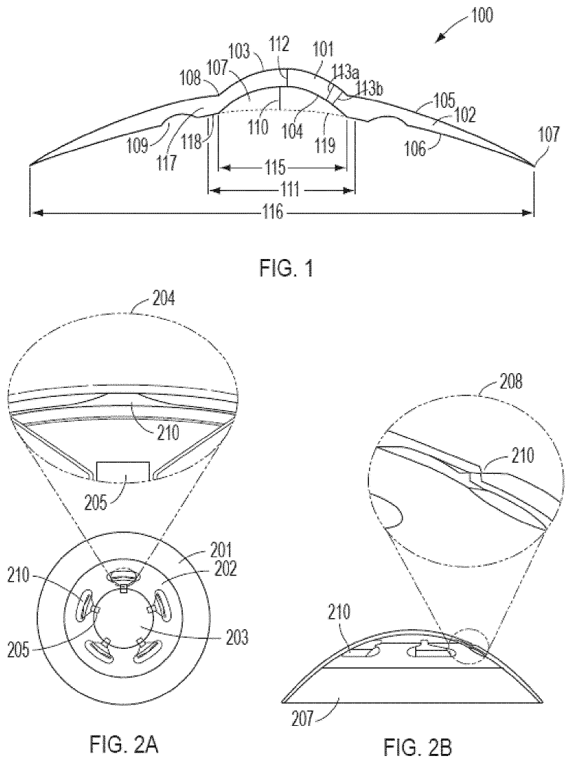

FIGS. 2A-2B show examples of valves, e.g., capillary valves. FIG. 2A shows a top view and FIG. 2B shows a cross-sectional view of a contact lens having a peripheral portion 201/202, a fish-mouth capillary valve 210 disposed between the anterior and the posterior surface of the lens, which is coupled to a fluid conduit 205, which is coupled to the optical or central portion 203, to a tear fluid reservoir, or to another feature in the posterior surface of the contact lens. FIG. 2A shows a top view of the contact lens with an amplified view 204 of a sectional fish-eye valve 210 coupling the anterior surface 207 of the lens to fluid conduit 205. FIG. 2B includes a detailed cross-sectional view 208 of a contact lens of an open fish-mouth valve capillary 210.

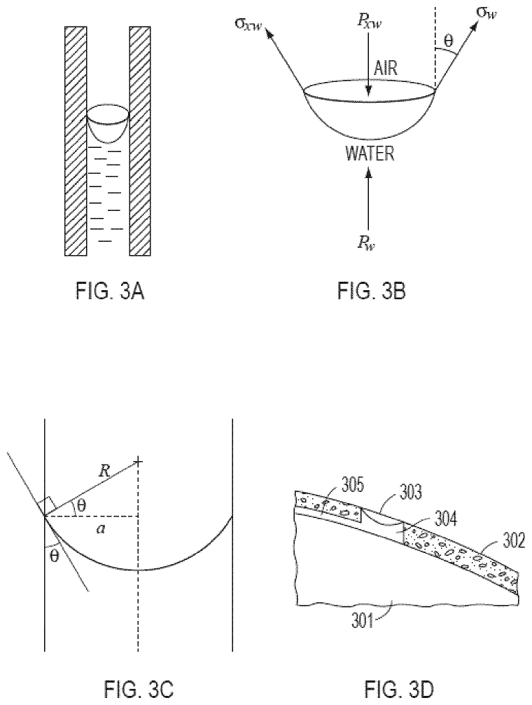

FIGS. 3A-3C illustrate forces that may occur within a fenestration in fluid communication with the fluid conduit and the anterior surface and the anterior environment. FIG. 3A shows a meniscus that is being created inside a fenestration. FIGS. 3B and 3C show a cross-sectional view of tear fluid within a fenestration and the parameters associated with the meniscus. The pressure across the meniscus is related to the radius and the surface tension γ by the equation Δp=2γ/R. The definitions of the parameters are illustrated in FIG. 3B and in FIG. 3C. FIG. 3D schematically shows a cross-sectional view of a capillary meniscus 303 formed within a fenestration 304 of the contact lens in fluid communication with a fluid conduit 305. The fenestration opening may be located on the anterior surface 302 of the lens. The fenestration can be located on a peripheral portion 301 of the lens, or elsewhere (e.g., in the central or optical region).

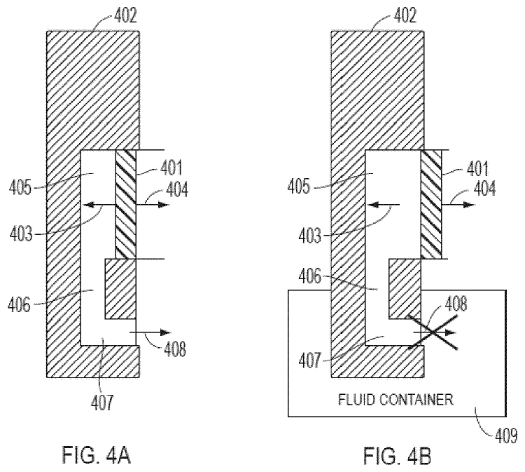

FIGS. 4A-4B show an example diagram of tear fluid transport in a contact lens having a single fenestration, which is either or open to air (e.g., at the anterior surface) or is fluidly coupled to a tear meniscus. In FIG. 4A the piston 401 represents the optical portion showing an applied force 403 that directs the optical portion 401 toward the cornea 402 and a restoring force 404 tending to pull the optical portion 401 away from the cornea 402. The restoring force 404 can be generated by the structure of the optical portion and may depend on, for example, the thickness of the central optical portion, the modulus (e.g., Young's modulus), the radius of curvature of different portions of the contact lens, and the sagittal height (e.g., distance between the most anterior point of the first posterior base curve and the second posterior base curve). An optical tear volume 405 is situated between the optical portion 404 and the cornea 402 and as shown in FIG. 4A is fluidly coupled by a fluid conduit 406 and to a fenestration 407. Capillary forces 408 generated within the fenestration 407 pull the tear fluid away from the optical tear volume 405 and may act similar to a closed valve. In FIG. 4B the fenestration 407 is fluidly coupled to a volume of tear fluid 409 such as a tear meniscus. Fluid coupling of the fenestration 407 to the source of tear fluid cancels the capillary force 408 and may act similar to an open valve such that the sum of the forces causes the optical portion 401 represented by the piston to overcome the suction force 403 and to pull away from the cornea 402 and thereby cause an increase in the optical tear volume 405.

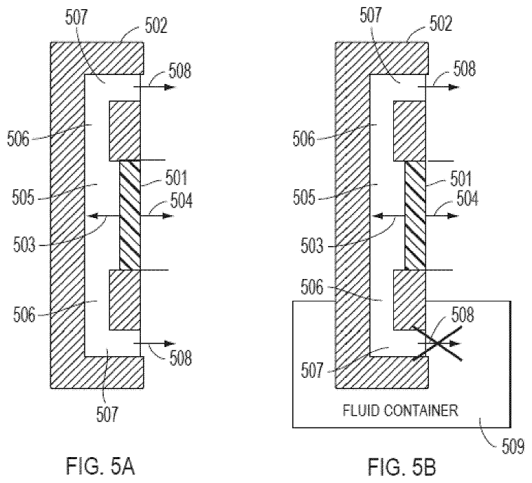

FIGS. 5A-5B show another diagram of tear fluid transport in a contact lens having two fenestrations 507. As shown in FIG. 5A, the position of the optical portion 501 represented by the piston is determined by a suction force 503, a structural force 504, and by the capillary forces 508 within the two fenestrations 507. When one or both of the fenestrations 507 are fluidly coupled to a volume of tear fluid 509 as shown in FIG. 5B, the position of the optical portion 501 moves away from the cornea 502 causing the optical tear volume 505 to increase. Fenestrations 507 are fluidly coupled to optical tear volume 505 by fluid conduit 506.

In some instances, multiple mechanisms may be used for actuating the change from the first configuration to the second configuration. For example, the mechanism for inducing a change in configuration can also comprise internal forces from within the lens. In such an example, the lens may be fabricated to be biased to remain in the second (i.e., non-conforming or bulging, where the first posterior base curve is steeper than the second posterior base curve) configuration in the absence of an applied pressure. For example, the physical structure of the contact lens can act as a force to cause the optical or central portion to assume the second configuration and bulge away from the cornea. In such cases, application of a force may force the contact lens to actuate and assume the first configuration (conforming to the cornea). For instance, a pressure may be applied to the posterior surface of the contact lens. Such a pressure may arise from the subject blinking, squinting, or other eyelid pressure. In some cases, the applied pressure may be stored by the contact lens to maintain the first (conforming) configuration. However, in the absence of the pressure applied to the posterior surface, or when the pressure is released from the lens, the lens may be actuated and may change back to the second configuration. For example, upon providing a sufficient tear volume (e.g., by the subject looking in a different or downward gaze) to the capillary valve, the burst pressures of the capillary valve may be exceeded, and fluid may be introduced past the capillary valve through the fluid conduit, for example, to the optical or central portion.

In some instances, the mechanism for actuation of the transition between the different configurations may comprise mechanical forces within the lens, which can cause the optical portion to transition between configurations, e.g., via an applied pressure. Tear fluid can flow into the volume between the posterior surface of the contact lens and the cornea to form an optical tear volume during or after the optical portion has transitioned between configurations such as from the first conforming configuration to the second non-conforming configuration. The mechanical forces and/or fluid dynamic forces can arise from the selection of the design of the contact lens and the selection of the materials forming different parts of the lens. For example, the amount of pressure that may need to be applied in order to actuate the transition between the configurations may be dependent on the thickness of the central optical portion, the modulus (e.g., Young's modulus), the radius of curvature of different portions of the contact lens, and the sagittal height (e.g., distance between the most anterior point of the first posterior base curve and the second posterior base curve) of the optical or central portion of the lens. Each design element, along with the material properties, e.g., modulus, hydrophobicity, and/or hydrophilicity of the materials forming different portions of the contact lens and the relative moduli of different portions of the optical or central portion may also contribute to the necessary applied force for configurational change.

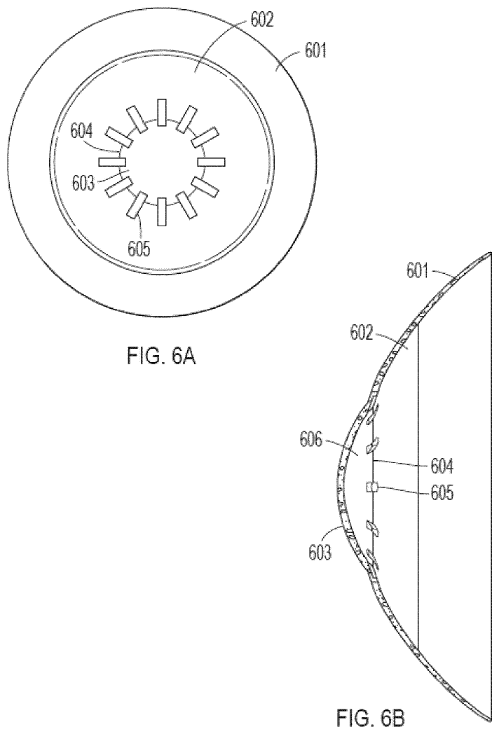

FIGS. 6A and 6B show a view of an anterior surface and a cross-sectional view, respectively, of an example of a contact lens provided by the present disclosure. The contact lens includes a first peripheral portion 601, a second peripheral portion 602, and an optical portion 603. The second peripheral portion 602 may be coupled to the central portion 603 at an interface 604. As shown in the cross-sectional view of FIG. 6B, the interface can be characterized by a discreet difference in the base curve of the second peripheral portion 602 and the base curve of the optical portion 603 and the interface 604 between the two regions. Fluid conduits 605 are shown to extend from the peripheral portion across the interface 604 into the optical portion 603 (which has an interior region 606) and represent discontinuities around the circumference of the interface 604.

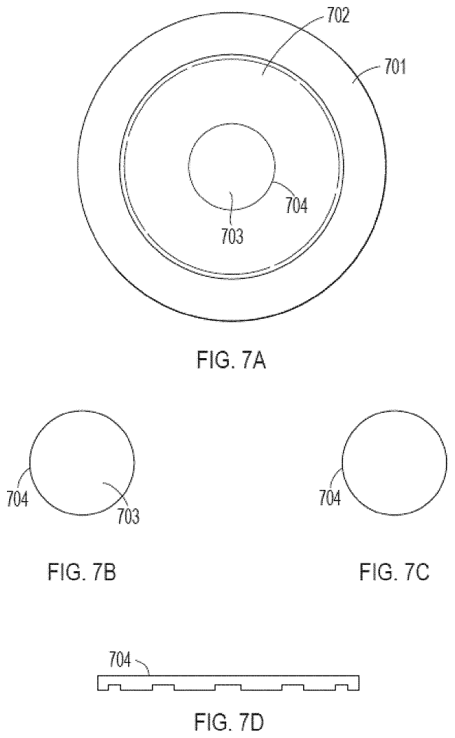

FIGS. 7A-7D show an example of a contact lens having a first peripheral portion 701, a second peripheral portion 702, an optical portion 703 and an interface 704. As shown in FIG. 7D, the interface 704 can have a discontinuous cross-sectional profile such that the thickness varies in a regular manner around the circumference of the interface. The differing thickness can be associated with one or more fluid conduits in the posterior surface of the dynamic contact lens that transect the transition zone. In other embodiments, the discontinuities can be irregular. FIG. 7B shows a view of the optical portion 703 and the circumference of the interface 704. FIG. 7C shows a top view of the interface 704.

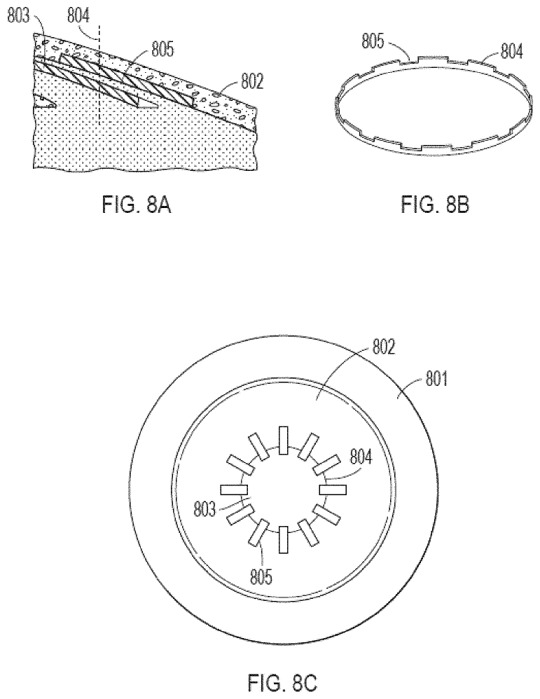

FIGS. 8A-8C show similar views of a contact lens that has discontinuities in the posterior surface of the contact lens that extend across the interface between the optical or central portion and the peripheral portion. The contact lens shown in FIGS. 8A-8C include first peripheral portion 801, second peripheral portion 802, optical portion 803, and an interface 804. The abrupt transition zone 804 includes irregularities 805 such as posterior fluid conduits extending across the interface such that the transition zone has a different thickness around the circumference.

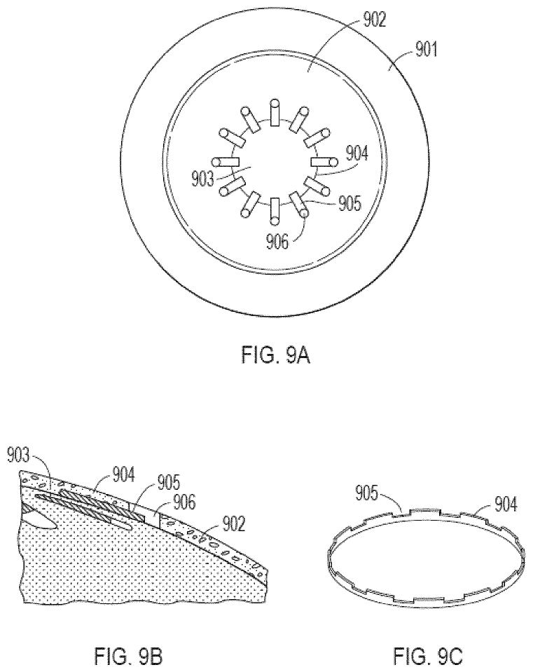

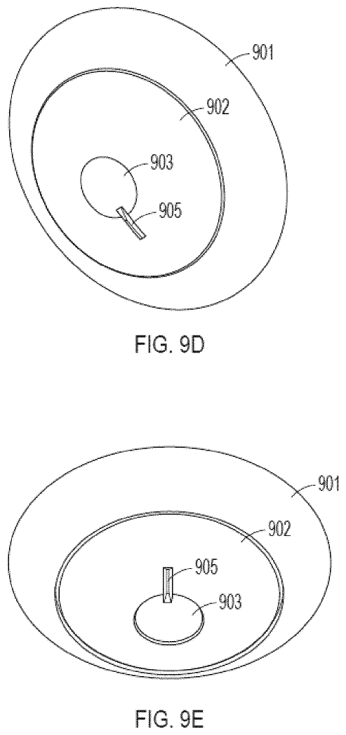

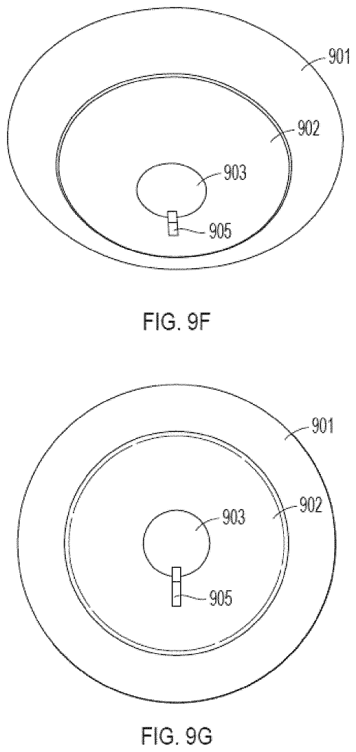

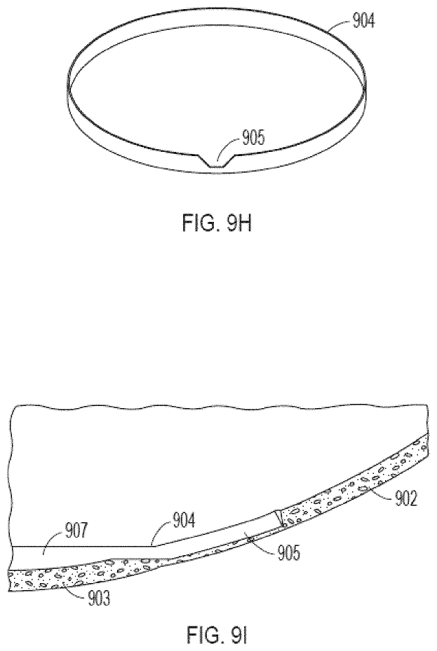

The dynamic contact lens shown in FIGS. 9A-9I include first peripheral portion 901, second peripheral portion 902, optical portion 903, and interface 904. The interface 904 includes irregularities 905 such as fluid conduits extending across the interface such that the interface 904 has a different thickness around the circumference. One end of each fluid conduit 905 is connected to a fenestration 906 and extends into optical region 903 to a tear chamber 907.

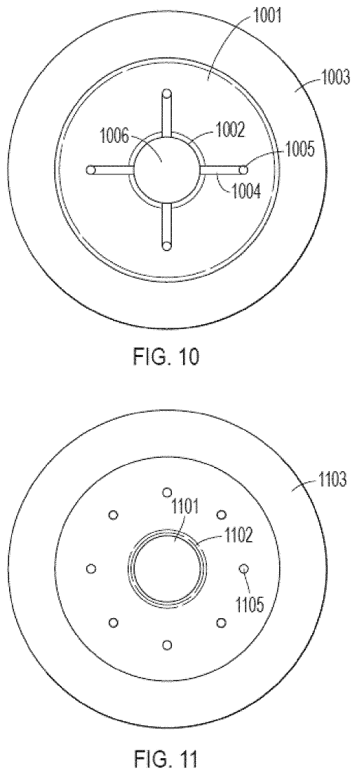

As an example, FIG. 10 shows a posterior surface of a dynamic contact lens provided by the present disclosure including an optical portion 1006, a first peripheral portion 1003, a second peripheral portion 1001, and an interface 1002. The dynamic contact lens includes radial fluid conduits 1004 extending from the second peripheral portion 1001 to the transition zone 1002, and a fenestration 1005 coupled to each of the fluid conduits 1004. As shown in FIG. 10, fluid conduit 1004 terminates at the interface area 1002.

FIG. 11 shows an anterior surface of another dynamic contact lens provided by the present disclosure including optical portion 1101, interface 1102, and peripheral portion 1103. The dynamic contact lens also includes 8 fenestrations 1105 through the peripheral portion of the dynamic contact lens. As shown in FIG. 11, the fluid conduits terminate at the interface 1102.

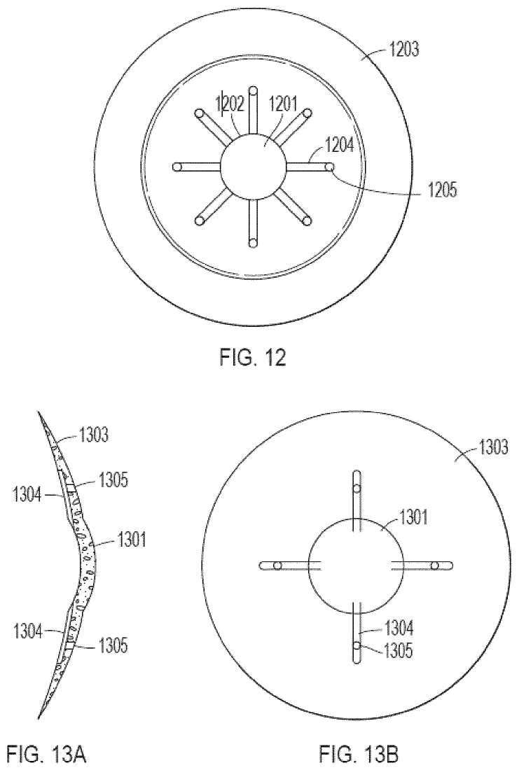

FIG. 12 shows the posterior surface of the same contact lens as shown in FIG. 11 including optical portion 1201, peripheral portion 1203, radial fluid conduits 1204 and fenestrations 1205 connected to each of the fluid conduits 1204.

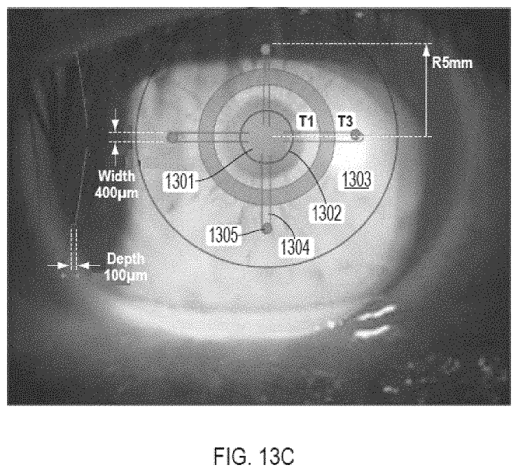

FIG. 13A shows a cross-sectional view of an example of a contact lens provided by the present disclosure including optical portion 1301, peripheral portion 1303, radial fluid conduits 1304, and fenestrations 1305. A view of the posterior surface of the same dynamic contact lens is shown in FIG. 13B and includes optical portion 1301, peripheral portion 1303, radial fluid conduits 1304, and fenestrations 1305. As shown in FIGS. 13A and 13B, the radial posterior grooves extend into the posterior surface of the optical portion 1301 or, as shown in FIG. 12, may terminate at the interface of the peripheral portion with the optical portion.

FIG. 13C shows the contact lens of FIGS. 13A and 13B on the eye of a patient and includes optical portion 1301, peripheral portion 1303, interface 1302, four radial fluid conduits 1304, and a fenestration 1305 connected to each of the posterior grooves 1304.

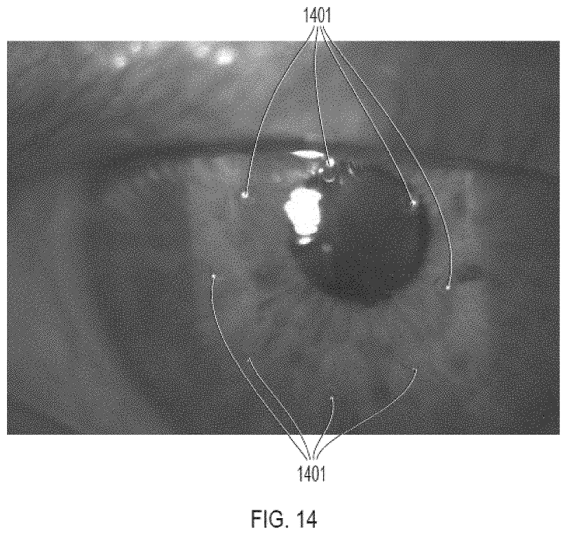

FIG. 14 shows a slit lamp bio-microscope image of a dynamic contact lens having eight (8) fenestrations on an eye of a patient. The fenestrations 1401 are visible as eight (8) white dots.

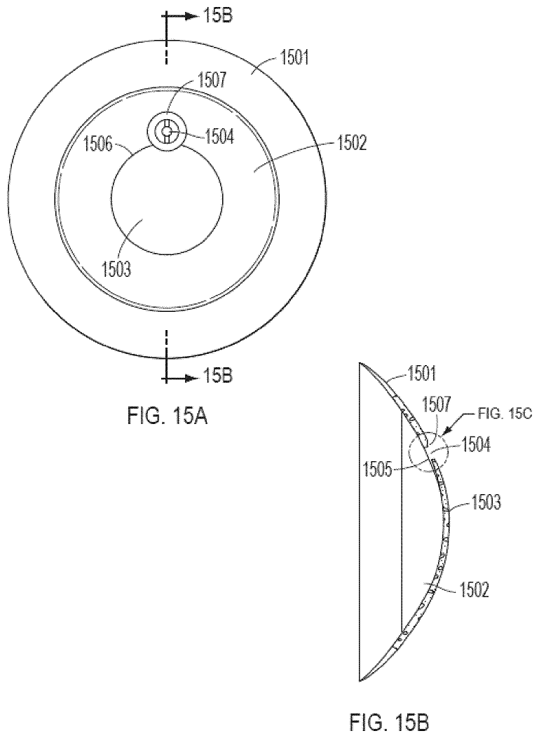

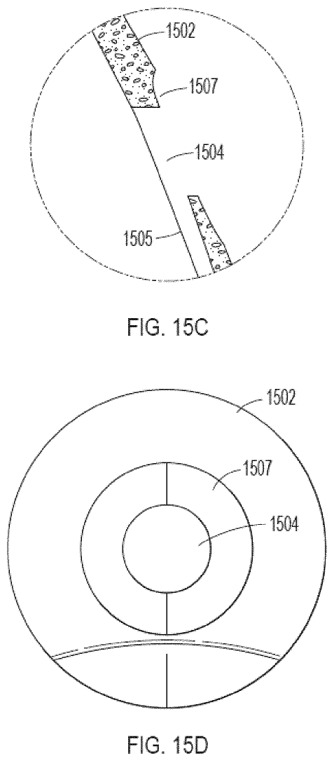

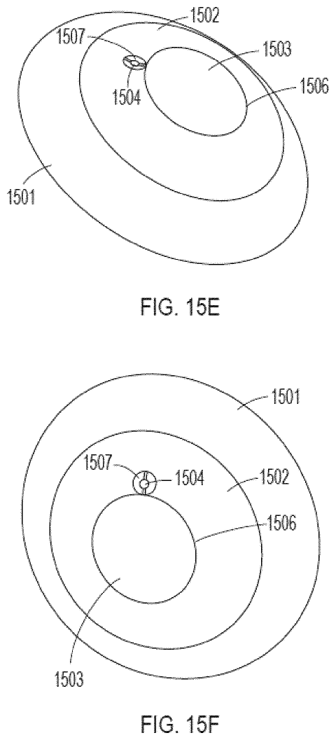

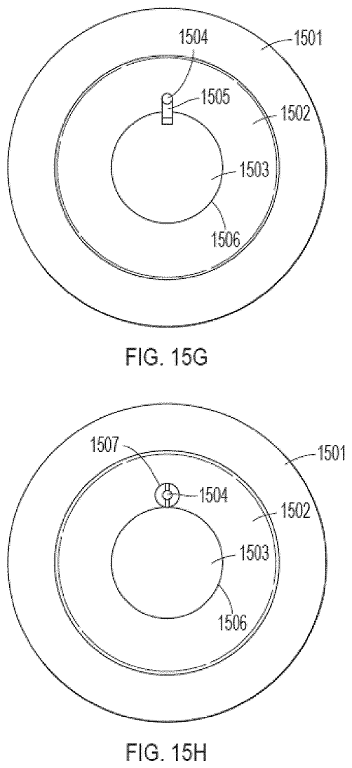

FIGS. 15A-15H show views of a contact lens having depressions and fenestrations. FIGS. 15A and 15B show views of the anterior surface and a cross-sectional view, respectively, of the dynamic contact lens. The dynamic contact lens shown in FIGS. 15A and 15B includes first peripheral portion 1501, second peripheral portion 1502, optical portion 1503, interface 1506, fenestration 1504 within depression 1507, and fluid conduit 1505. FIG. 15C shows a magnified cross-sectional view illustrating the depression 1507 and fenestration 1504, which are coupled to a fluid conduit 1505 in the posterior surface of the contact lens. FIG. 15C shows a depression 1507 and fenestration 1504 in peripheral portion 1502 coupled to fluid conduit 1505. FIG. 15D shows a magnified top view of the elements shown in FIG. 15C including peripheral posterior surface 1502, depression 1507 and fenestration 1504. FIG. 15E shows a view of the posterior surface of a dynamic contact lens including first peripheral portion 1501, second peripheral portion 1502, optical portion 1503, the interface 1506 between the optical portion and the second peripheral portion, and depression 1507 with a fenestration 1504. FIG. 15F shows the anterior surface of the dynamic contact lens shown in FIG. 15E including first peripheral portion 1501, second peripheral portion 1502, optical portion 1503, and depression 1507 with a fenestration 1504. As shown in FIGS. 15D and 15F, the depression and fenestration are located in proximity to the interface 1506 and to the optical portion 1503. FIG. 15G shows a view of the posterior surface of a dynamic contact lens including first peripheral portion 1501, second peripheral portion 1502, optical portion 1503, and fluid conduit 1505 with a fenestration 1504. Fluid conduit 1505 extends from the fenestration into the optical portion 1503. FIG. 15H shows the anterior surface of the dynamic contact lens shown in FIG. 15G including first peripheral portion 1501, second peripheral portion 1502, optical portion 1503, and depression 1507 with a fenestration 1504.

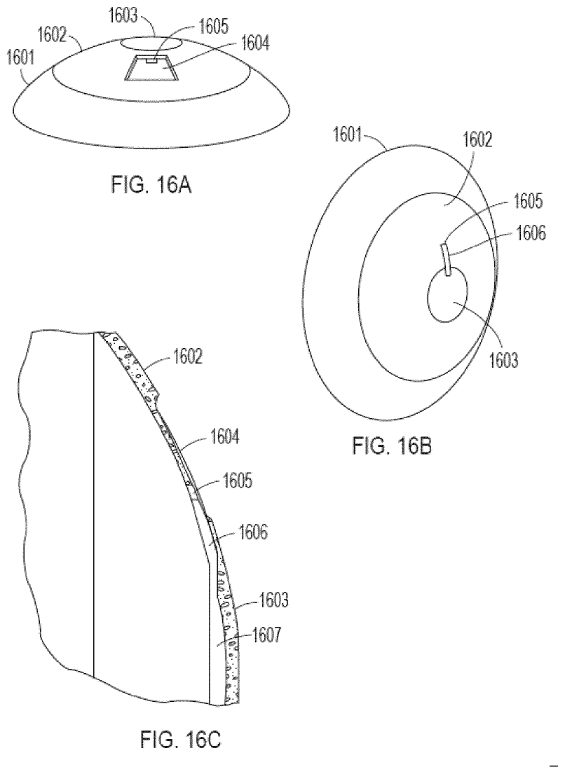

FIGS. 16A-16C show side, perspective, and cross-sectional views, respectively, of a contact lens having a first peripheral portion 1601, a second peripheral portion 1602, an optical portion 1603, and a depression 1604 on the anterior surface of the second peripheral portion 1602 with a fenestration 1605 in the bottom of the depression 1604. As shown in FIG. 16B, on the posterior surface, a fluid conduit 1606 is coupled to the fenestration 1605 and extends from the second peripheral portion 1602 into the optical portion 1603. A cross-sectional view of the dynamic contact lens is shown in FIG. 16C, and in addition the elements shown in FIGS. 16A-16B, shows that the fluid conduit 1606 narrows toward the optical portion 1603 and is fluidically coupled to optical tear volume 1607.

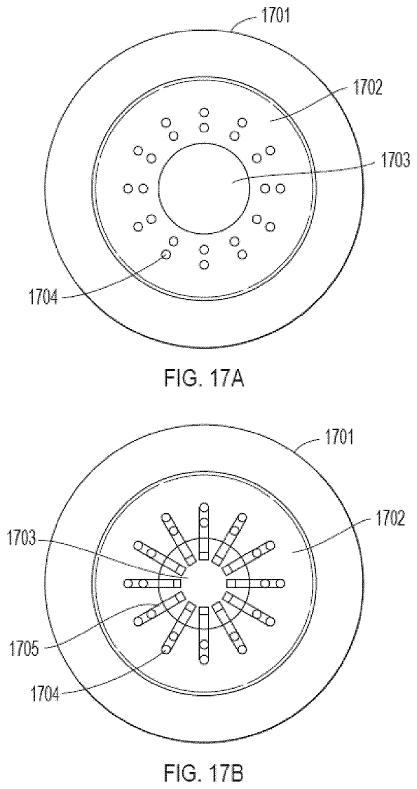

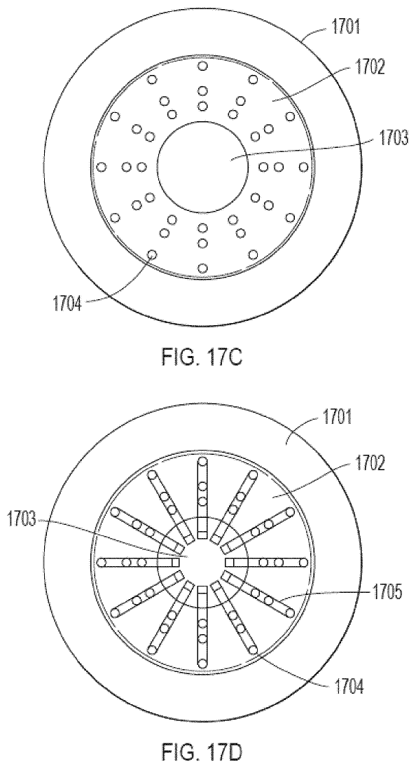

An example of multiple fenestrations for coupling to a tear fluid volume is shown in FIGS. 17A-17D. FIGS. 17A-17D show dynamic contact lenses having a first peripheral portion 1701, a second peripheral portion 1702, and an optical portion 1703. Fenestrations 1704 are radially disposed around the optical portion at various radial distances from the center of the optical portion 1703. FIGS. 17A and 17B show anterior and posterior views, respectively, of a contact lens having 24 fenestrations disposed in 12 radial segments of two fenestrations each. As shown in FIG. 17B, the fenestrations 1704 are coupled to fluid conduits 1705 that extend from the second peripheral portion 1702 into the optical portion 1703. FIGS. 17C and 17D show anterior and posterior views, respectively, of a dynamic contact lens having 36 fenestrations disposed in 12 radial segments of three fenestrations each, where the fenestrations 1704 are disposed at various radial distances from the center of the optical portion 1703. As shown in FIG. 17D, each of the fenestrations is coupled to a fluid conduit 1705 that extends from the second peripheral portion 1702 into the optical portion 1703.

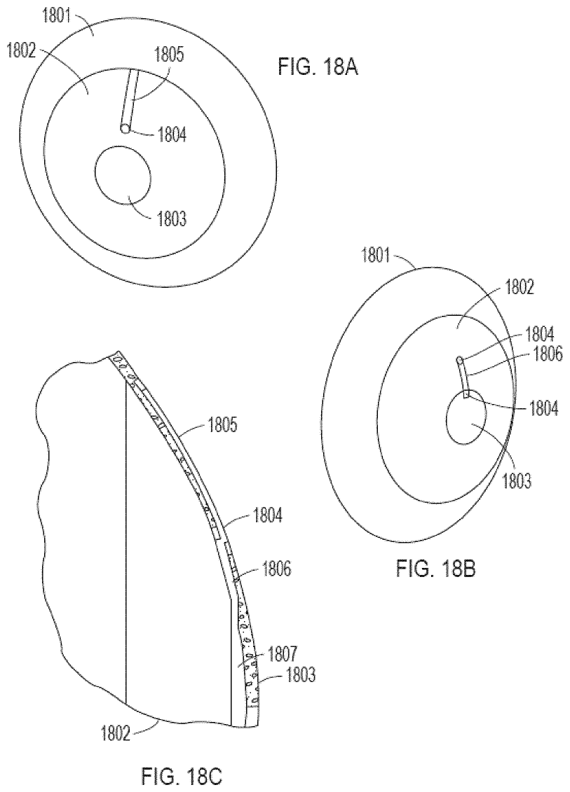

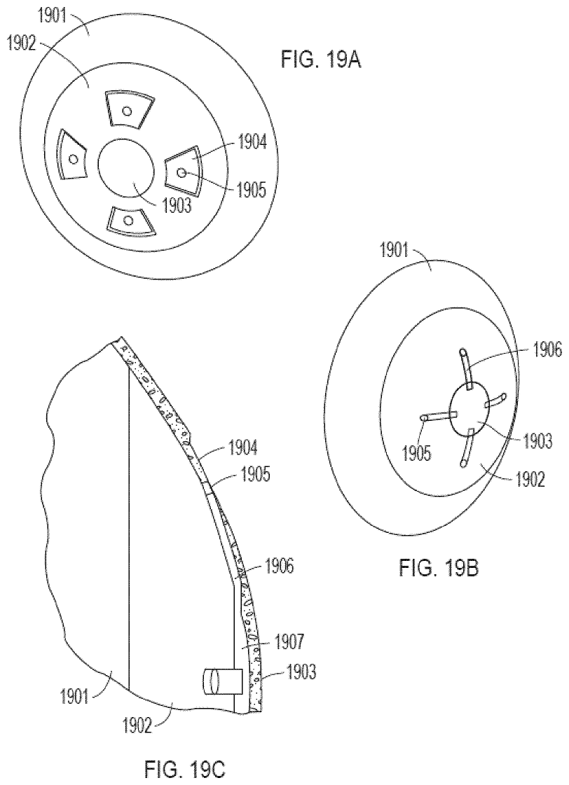

FIGS. 18A-18C and 19A-19C show examples of anterior fluid conduits that extend radially from the periphery of the dynamic contact lens toward the optical portion and are connected to a fenestration, which in turn is connected to a posterior fluid conduit. When in contact with a first volume of fluid (e.g., the tear volume), a second volume of tear fluid can enter through the anterior fluid conduit, through the fenestration, through the posterior fluid conduit and into the optical tear volume by capillary and/or a combination of forces. FIGS. 18A-18C show first peripheral portion 1801, second peripheral portion 1802, optical portion 1803, radial fluid conduit 1805, and fenestration 1804. FIG. 18B shows fenestration 1804 connected to posterior fluid conduit 1806 that extends from the fenestration 1804 into the optical zone 1803. FIG. 18C shows a cross-sectional view including anterior fluid conduit 1805 connected to posterior groove 1806 by fenestration 1804. Posterior fluid conduit 1806 narrows at the transition zone interface with the optical portion 1803, and couples the anterior fluid conduit 1805 to the optical tear volume 1807. Anterior fluid conduit 1805 can be configured to fluidly couple to a tear meniscus of the eye such as during downward gaze.

FIGS. 19A-19C show views of the anterior surface, posterior surface, and cross-section, respectively, of an example of a contact lens. As shown in FIG. 19A, the lens includes first peripheral portion 1901, second peripheral portion 1902, optical portion 1903, and depressions 1904 in the anterior surface of the second peripheral portion 1902 with a fenestration 1905 in each of the depressions 1904. As shown in FIG. 19B, on the posterior surface, a fluid conduit 1906 extends from the fenestration 1905 into the optical portion 1903. As shown in FIG. 19C, the depression 1904 is coupled to the tear volume 1907 by the fenestration 1905 and the posterior fluid conduit 1906. Anterior depression 1904 can be configured to fluidly couple to a tear meniscus of the eye such as during downward gaze.

As described herein, upon contacting the valve (e.g., capillary valve) with a first volume of tear fluid, the capillary valve is configured to open and allow a second volume of tear fluid to enter the optical or central portion of the lens via the fluid conduit. Introduction of tear fluid into the optical or central portion may thereby actuate the optical or central portion from the first configuration to the second configuration. The capillary valve may be positioned to contact the first volume of tear fluid when the subject looking in a downward gaze. In some instances, the lens is configured to be expel the volume of tear fluid when the subject blinks, squints or otherwise applies a pressure to the contact lens in order to return the optical or central portion to the first configuration. In some cases, the first configuration is maintained when the subject looks in a forward gaze. In some cases, the first configuration is maintained after application of the pressure (e.g., via squinting) and when the contact lens and the capillary valve are exposed to air.

The burst pressure of the valve may be at least about 10 Pa, 20 Pa, 30 Pa, 40 Pa, 50 Pa, 60 Pa, 70 Pa, 80 Pa, 90 Pa, 100 Pa, 200 Pa, 300 Pa, 400 Pa, 500 Pa, 600 Pa, 700 Pa, 800 Pa, 900 Pa, 1,000 Pa, 2,000 Pa, 3,000 Pa, 4,000 Pa, 5,000 Pa, 6,000 Pa, 7,000 Pa, 8,000 Pa, 9,000 Pa, 10,000 Pa, 11,000 Pa, 12,000 Pa, 13,000 Pa, 14,000 Pa, 15,000 Pa, 16,000 Pa, 17,000 Pa, 18,000 Pa, 19,000 Pa, 20,000 Pa, 30,000 Pa, 40,000 Pa, 50,000 Pa, 60,000 Pa, 70,000 Pa, 80,000 Pa, 90,000 Pa, 100,000 Pa, or more. The burst pressure may be at most about 100,000 Pa, 90,000 Pa, 80,000 Pa, 70,000 Pa, 60,000 Pa, 50,000 Pa, 40,000 Pa, 30,000 Pa, 20,000 Pa, 19,000 Pa, 18,000 Pa, 17,000 Pa, 16,000 Pa, 15,000 Pa, 14,000 Pa, 13,000 Pa, 12,000 Pa, 11,000 Pa, 10,000 Pa, 9,000 Pa, 8,000 Pa, 7,000 Pa, 6,000 Pa, 5,000 Pa, 4,000 Pa, 3,000 Pa, 2,000 Pa, 1,000 Pa, 900 Pa, 800 Pa, 700 Pa, 600 Pa, 500 Pa, 400 Pa, 300 Pa, 200 Pa, 100 Pa, 90 Pa, 80 Pa, 70 Pa, 60 Pa, 50 Pa, 40 Pa, 30 Pa, 20 Pa, 10 Pa, or less. The burst pressure may be within a range defined by any two of the preceding values. For instance, the burst pressure may be within a range from 40 Pa to 11,000 Pa, 200 Pa to 20,000 Pa, or 500 Pa to 50,000 Pa.

The optical or central portion of the contact lens may have any useful diameter. The diameter may be at least about 0.1 mm, 0.2 mm, 0.3 mm, 0.4 mm, 0.5 mm, 0.6 mm, 0.7 mm, 0.8 mm, 0.9 mm, 1 mm, 2 mm, 3 mm, 4 mm, 5 mm, 6 mm, 7 mm, 8 mm, 9 mm, 10 mm, or more. The diameter may be at most about 10 mm, 9 mm, 8 mm, 7 mm, 6 mm, 5 mm, 4 mm, 3 mm, 2 mm, 1 mm, 0.9 mm, 0.8 mm, 0.7 mm, 0.6 mm, 0.5 mm, 0.4 mm, 0.3 mm, 0.2 mm, 0.1 mm, or less. The diameter may be within a range defined by any two of the preceding values. For instance, the diameter may be within a range from 0.5 mm to 5 mm. In some instances, the central portion spans a diameter of about 2 millimeters mm to about 7 mm.

The optical or central portion of the contact lens may have any useful thickness. The optical portion may comprise a maximum thickness of at least about 10μm, 20μm, 30 μm, 40 μm, 50 μm, 60 μm, 70 μm, 80μm, 90 μm, 100 μm, 200 μm, 300μm, 400μm, 500 μm, 600μm, 700 μm, 800 μm, 900 μm, 1,000μm, or more. The optical portion may comprise a maximum thickness of at most about 1,000 μm, 900 μm, 800 μm, 700 μm, 600 μm, 500 μm, 400 μm, 300 μm, 200 μm, 100 μm, 90 μm, 80 μm, 70 μm, 60 μm, 50 μm, 40 μm, 30 μm, 20 μm, 10 μm, or less. The optical portion may comprise a maximum thickness that is within a range defined by any two of the preceding values. The optical portion can comprise a maximum thickness within a range, for example, from 20 μm to 600 μm, from 50 μm to 500 μm, from 100 μm to 400 μm, or from 50 μm to 300 μm. The optical portion may comprise a center thickness of at least about 10 μm, 20 μm, 30 μm, 40 μm, 50 μm, 60 μm, 70 μm, 80 μm, 90 μm, 100 μm, 200 μm, 300 μm, 400 μm, 500 μm, 600 μm, 700 μm, 800 μm, 900 μm, 1,000 μm, or more. The optical portion may comprise a center thickness of at most about 1,000 μm, 900 μm, 800 μm, 700 μm, 600 μm, 500 μm, 400 μm, 300 μm, 200 μm, 100 μm, 90 μm, 80 μm, 70 μm, 60 μm, 50 μm, 40 μm, 30 μm, 20 μm, 10 μm, or less. The optical portion may comprise a center thickness that is within a range defined by any two of the preceding values. The optical portion can comprise a center thickness within a range, for example, from 20 μm to 600 μm, from 50 μm to 500 μm, from 100 μm to 400 μm, or from 50 μm to 300 μm. The optical portion can be characterized by a substantially uniform thickness, by a center thickness that is the same as a thickness as the peripheral portion, by a center thickness that is greater than a thickness of the peripheral portion, or by a center thickness that is less than a thickness of the peripheral portion. In other words, the thickness of the optical portion can increase toward the center of the optical portion, can decrease toward the center of the optical portion, or can be substantially constant throughout.

As described herein, the pressure sufficient to have the dimension change non-linearly may depend on at least one or more parameters of the contact lens. For example, the parameter may comprise a thickness, a modulus, a diameter of the optical or central portion, and a sagittal height. As an example, a thicker optical portion may require that a greater pressure or force is necessary to be applied to the contact lens (e.g., at the posterior surface of the optical or central portion) in order for the contact lens to be actuated to transition to a different configuration. Similarly, an optical or central portion that has a higher modulus may require a greater pressure or force to be actuated to transition to a different configuration. In yet another example, the optical portion diameter may similarly influence the amount of force or pressure required to actuate the change between configurations. For example, a larger diameter of the optical or central portion may require a lower amount of force or pressure to actuate the change between configurations.

The dimension at which the posterior surface of the lens is disposed from a cornea of a subject may be a sagittal height. As described herein, the sagittal height may be the distance between the most anterior point in the first posterior base curve and the most anterior point in the second posterior base curve (e.g., the most anterior portion of the posterior base curve of the peripheral portion). The optical or central portion of the contact lens, e.g., in the first configuration or in the second configuration, may be characterized by a sagittal height of at least about 0 μm, 0.1 μm, 0.5 μm, 1 μm, 5 μm, 10 μm, 20 μm, 30 μm, 40 μm, 50 μm, 60 μm, 70 μm, 80 μm, 90 μm, 100 μm, 200 μm, 300 μm, 400 μm, 500 μm, 600 μm, 700 μm, 800 μm, 900 μm, 1,000 μm, or more. The optical or central portion may be characterized by a sagittal height of at most about 1,000 μm, 900 μm, 800 μm, 700 μm, 600 μm, 500 μm, 400 μm, 300 μm, 200 μm, 100 μm, 90 μm, 80 μm, 70 μm, 60 μm, 50 μm, 40 μm, 30 μm, 20 μm, 10 μm, 5 μm, 1 μm, 0.5 μm, 0.1 μm or less. The optical or central portion may be characterized by a sagittal height that is within a range defined by any two of the preceding values. The optical or central portion can be characterized by a sagittal height within a range, for example, from 0 μm to 250 μm such as from 10 μm to 100 μm. Each configuration of the contact lens (e.g., the first configuration or the second configuration) may be characterized by a different sagittal height. For example, in the first configuration, the contact lens may be substantially conforming with the cornea and may have a lower sagittal height (e.g., between 0 μm and 20 μm) than when the contact lens is in the second (non-conforming) configuration.

The dimension at which the posterior surface of the lens is disposed from a cornea of a subject may be a gap height. The gap height may be the distance between the posterior surface of the contact lens and the cornea. The gap height may be the distance between the cornea and the most anterior point in the posterior base curve of the contact lens (e.g., the most anterior point of the first posterior base curve of the optical portion). The optical or central portion of the contact lens, e.g., in the first configuration or in the second configuration, may be characterized by a gap height of at least about 0 μm, 0.1 μm, 0.5 μm, 1 μm, 5 μm, 10 μm, 20 μm, 30 μm, 40 μm, 50 μm, 60 μm, 70 μm, 80 μm, 90 μm, 100 μm, 200 μm, 300 μm, 400 μm, 500 μm, 600 μm, 700 μm, 800 μm, 900 μm, 1,000 μm, or more. The optical or central portion may be characterized by a gap height of at most about 1,000 μm, 900 μm, 800 μm, 700 μm, 600 μm, 500 μm, 400 μm, 300 μm, 200 μm, 100 μm, 90 μm, 80 μm, 70 μm, 60 μm, 50 μm, 40 μm, 30 μm, 20 μm, 10 μm, 5 μm, 1 μm, 0.5 μm, 0.1 μm or less. The optical or central portion may be characterized by a gap height that is within a range defined by any two of the preceding values. The optical or central portion can be characterized by a gap height within a range, for example, from 0 μm to 250 μm such as from 10 μm to 100 μm. Each configuration of the contact lens (e.g., the first configuration or the second configuration) may be characterized by a different gap height. For example, in the first configuration, the contact lens may be substantially conforming with the cornea and may have a lower gap height than when the contact lens is in the second (non-conforming) configuration. In some instances, the gap height and the sagittal height may be substantially the same. For example, when the second posterior base curve is substantially the same as the curvature of the cornea, the sagittal height and the gap height may be substantially the same.

In FIG. 1 the sagittal height 110 is at the center of the optical or central portion which is located at the center geometric axis of the lens 112. The sagittal height decreases toward the periphery of the optical portion 115 forming a lens shape. In FIG. 1, the optical or central region 111 is slightly larger than the diameter of the optical portion 111. When worn on the eye of a patient the distance 110 can also be referred to as the gap height and is the distance between the posterior surface of the optical portion (the optical posterior surface) and the anterior surface of the cornea. The optical portion refers to the portion of the lens used for vision. The diameter of the optical portion can be larger than that of the optical region of the eye. In some embodiments, the diameter of the optical portion can be less than the diameter of the optical region of the eye. In some embodiments, the diameter of the optical portion can be similar to, the same as, or larger than the diameter of the optical region of the eye.

As shown in FIG. 1, the center sagittal height 110 is defined as the distance between the extended curvature of the peripheral posterior surface 106 which is configured to conform to the cornea and the posterior surface at the center of optical portion 104. The optical portion can be characterized by a plurality of sagittal heights depending on the location with respect to the center axis of the optical portion. The sagittal height will be a maximum in the center and will decrease toward the periphery of the optical portion. The optical portion 101 comprises a center thickness 112 and examples of two radial sagittal thickness are identified as 113a and 113b. In FIG. 1 the diameter of the optical region 111 is shown as being slightly larger than the diameter 115 of the optical portion. The dynamic contact lens 100 has a diameter 116. As shown in FIG. 1 the optical portion 101, the peripheral portion 102, and the optical region of the eye can be co-aligned about the center geometric axis of the dynamic contact lens.

The dimension at which the posterior surface of the lens is disposed from a cornea can be a difference in curvature between the posterior surface and the surface of the cornea. For example, the difference may be a difference in a radius of curvature. The difference in curvature between the posterior surface and the surface of the cornea may be within a range. The difference in curvature between the posterior surface and the surface of the cornea may be at most about 10 mm, 9.5 mm, 9 mm, 8.5 mm, 8 mm, 7.5 mm, 7 mm, 6.5 mm, 6 mm, 5.5 mm, 5 mm, 4.5 mm, 4 mm, 3.5 mm, 3 mm, 2.5 mm, 2 mm, 1.5 mm, 1 mm, or less. The difference in curvature between the posterior surface and the surface of the cornea may be at least about 1 mm, 1.5 mm, 2 mm, 2.5 mm, 3 mm, 3.5 mm, 4 mm, 4.5 mm, 5 mm, 5.5 mm, 6 mm, 6.5 mm, 7 mm, 7.5 mm, 8 mm, 8.5 mm, 9 mm, 9.5 mm, 10 mm, or more. The difference in curvature between the posterior surface and the surface of the cornea may be within a range defined by any two of the preceding values. The optical posterior surface can have a difference in radius of curvature, for example, from 1 mm to 2 mm, from 3 mm to 7 mm, from 3.5 mm to 6.5 mm, or from 4 mm to 6 mm.

In some cases, a change in the dimension at which the posterior surface of the lens is disposed from the cornea may concomitantly result in a change in another dimension. For example, a change in the sagittal or gap height of the optical or central portion of the contact lens may also require a change in the radius of curvature of the optical or central portion.

The change in dimension can result in a change in optical power. The change in optical power can be about 0.1 diopters, 0.2 diopters, 0.3 diopters, 0.4 diopters, 0.5 diopters, 0.6 diopters, 0.7 diopters, 0.8 diopters, 0.9 diopters, 1 diopter, 1.5 diopters, 2 diopters, 2.5 diopters, 3 diopters, 3.5 diopters, 4 diopters, 4.5 diopters, 5 diopters, 5.5 diopters, 6 diopters, 6.5 diopters, 7 diopters, 7.5 diopters, 8 diopters, 8.5 diopters, 9 diopters, 9.5 diopters, 10 diopters, 11 diopters, 12 diopters, 13 diopters, 14 diopters, 15 diopters, 16 diopters, 17 diopters, 18 diopters, 19 diopters, 20 diopters. The change in optical power can be in a range, e.g., between 0.25 to 10 diopters, between 1 to 20 diopters, or between 0.5 to 20 diopters. The change in dimension can result in a decrease in optical power.

The change in optical power may result in a flattening of the anterior surface or the posterior surface of the contact lens. Alternatively, the change in optical power may result in a bulging of the anterior surface or the posterior surface of the contact lens. In some cases, the first configuration may conform to the cornea, and the second configuration may be non-conforming to the cornea. In such cases, the flattening of the anterior surface or the posterior surface of the contact lens may be performed by application of a pressure to the contact lens (e.g., via a subject blinking or squinting or looking in a different gaze).

The dimension from the cornea which the posterior surface is disposed may change non-linearly as a function of a pressure applied to the posterior surface. The contact lens may flatten (i.e., the sagittal height can decrease) in response to pressure in a non-linear manner. The non-linear change may be multiphasic or continuous. For example, the non-linear change may be defined as a non-linear curve having at least two segments. The at least two segments may, for example, comprise a first steep segment where the dimension (e.g., sagittal height, radius of curvature) changes in response to the applied pressure at a first rate and a second slight segment where the dimension changes in response to the pressure at a second rate less than the first rate. In some cases, the non-linear curve further comprises a third gradual segment, where the dimension (e.g., sagittal height, radius of curvature changes in response to the pressure at a third rate between the first and second rates.

The pressure applied to the posterior surface that is sufficient to flatten the contact lens may be at least about 100 Pascals (Pa), at least about 200 Pa, at least about 300 Pa, at least about 400 Pa, at least about 500 Pa, at least about 600 Pa, at least about 700 Pa, at least about 800 Pa, at least about 900 Pa, at least about 1,000 Pa, at least about 2,000 Pa, at least about 3,000 Pa, at least about 4,000 Pa, at least about 5,000 Pa, at least about 6,000 Pa, at least about 7,000 Pa, at least about 8,000 Pa, at least about 9,000 Pa, at least about 10,000 Pa, at least about 15,000 Pa, at least about 20,000 Pa, at least about 25,000 Pa, at least about 30,000 Pa or more. In some cases, the pressure applied to the posterior surface that is sufficient to flatten the contact lens may be in a range of pressures, e.g., between 200 Pa and 20,000 Pa or between 200 Pa and 10,000 Pa.

Following actuation, the optical or central portion may convert from the first configuration to the second configuration in less than about 1 minute, 50 seconds, 40 seconds, 30 seconds, 20 seconds, 10 seconds, 5 seconds, 4 seconds, 3 seconds, 2 seconds, 1 second, or less. The optical or central portion may convert from the first configuration to the second configuration in about 1 second, 2 seconds, 3 seconds, 4 seconds, 5 seconds, 10 seconds, 20 seconds, 30 seconds, 40 seconds, 50 seconds, 1 minute or more. The optical or central portion may convert from the first configuration to the second configuration in a range of durations, e.g., from 2-5 seconds.

The contact lens may be fabricated from any suitable material. The contact lens may comprise one or more polymers. In some embodiments, the contact lens comprises silicone or a silicone hydrogel. The contact lens can comprise polymethyl methacrylate (PMMA), poly hydroxy ethyl methacrylate (poly-HEMA), poly vinyl alcohol (PVA), polyethylene glycol (PEG), or other polymer. In some cases, the contact lens can comprise a coating, such that can comprise a polymer (e.g., PEG, PVA, poly-HEMA, PMMA, PVA).

The Young's modulus of the contact lens, or a portion thereof (e.g., the optical or central portion) may range from about 0.1 megapascals (MPa) to about 1000 MPa. The Young's modulus of the central portion may be at least about 0.1 MPa, 0.2 MPa, 0.3 MPa, 0.4 MPa, 0.5 MPa, 0.6 MPa, 0.7 MPa, 0.8 MPa, 0.9 MPa, 1 MPa, 2 MPa, 3 MPa, 4 MPa, 5 MPa, 10 MPa, 20 MPa, 30 MPa, 40 MPa, 50 MPa, 60 MPa, 70 MPa, 80 MPa, 90 MPa, 100 MPa, 200 MPa, 300 MPa, 400 MPa, 500 MPa, 600 MPa, 700 MPa, 800 MPa, 900 MPa, 1000 MPa or more. The Young's modulus of the central portion may be at most about 100 MPa, 900 MPa, 800 MPa, 700 MPa, 600 MPa, 500 MPa, 400 MPa, 300 MPa, 200 MPa, 100 MPa, 90 MPa, 80 MPa, 70 MPa, 60 MPa, 50 MPa, 40 MPa, 30 MPa, 20 MPa, 10 MPa, 5 MPa, 4 MPa, 3 MPa, 2 MPa, 1 MPa, 0.9 MPa, 0.8 MPa, 0.7 MPa, 0.6 MPa, 0.5 MPa, 0.4 MPa, 0.3 MPa, 0.2 MPa, 0.1 MPa, or less. The Young's modulus of the central portion may be within a range defined by any two of the preceding values. The material forming the optical portion can have a Young's modulus, for example, within a range from 0.05 MPa to 8 MPa, from 0.1 MPa to 30 MPa, from 10 MPa to 100 MPa, from 0.1 MPa to 3 MPa, from 0.1 MPa to 2 MPa, or from 0.5 MPa to 1 MPa.

In another aspect, disclosed herein is a contact lens comprising: (i) a central portion having a first configuration and a second configuration when applied to a cornea of a subject, such that in the first configuration, a posterior surface of the central portion is disposed at a first dimension from the cornea of the subject resulting in a first optical power, and such that in the second configuration, the posterior surface of the central portion is disposed at a second dimension from said cornea resulting in a second optical power, wherein said first dimension is different than said second dimension; and (ii) a valve coupled to said central portion and configured to actuate said central portion from said first configuration to said second configuration thereby dynamically adjusting an optical power of said contact lens.

In another aspect of the present disclosure, provided herein is a method for dynamically changing an optical power of a contact lens, said method comprising: (a) providing a contact lens comprising a valve coupled to a central portion, said central portion having an optical power, (b) providing a fluid volume sufficient to overcome a burst pressure threshold of said valve, thereby generating a change in a radius of curvature of said central portion of said contact lens and dynamically changing said optical power

### Computer Systems

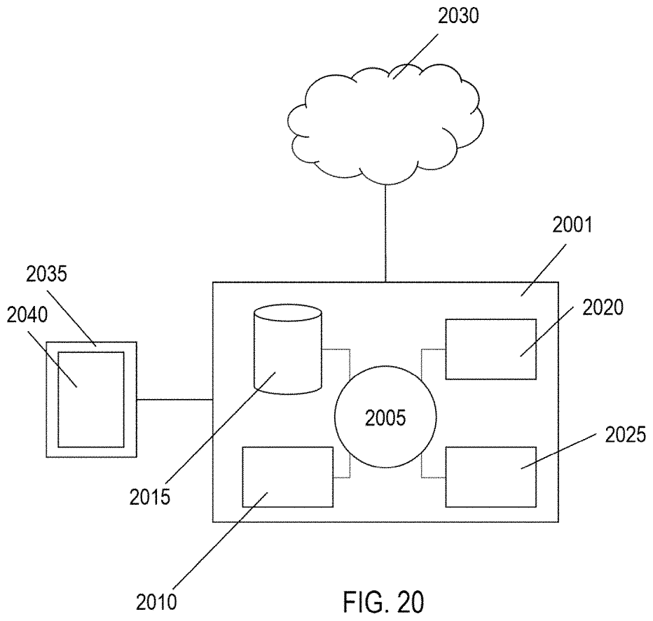

The present disclosure provides computer systems that are programmed to implement methods of the disclosure. FIG. 20 shows a computer system 2001 that is programmed or otherwise configured to perform a finite element analysis (FEA). The computer system 2001 can regulate various aspects of the FEA of the present disclosure, such as, for example, modifying input parameters, calculating pressures as a function of a dimension of the contact lens, and modeling the contact lens in computer aided design (CAD). The computer system 2001 can be an electronic device of a user or a computer system that is remotely located with respect to the electronic device. The electronic device can be a mobile electronic device.

The computer system 2001 includes a central processing unit (CPU, also “processor” and “computer processor” herein) 2005, which can be a single core or multi core processor, or a plurality of processors for parallel processing. The computer system 2001 also includes memory or memory location 2010 (e.g., random-access memory, read-only memory, flash memory), electronic storage unit 2015 (e.g., hard disk), communication interface 2020 (e.g., network adapter) for communicating with one or more other systems, and peripheral devices 2025, such as cache, other memory, data storage and/or electronic display adapters. The memory 2010, storage unit 2015, interface 2020 and peripheral devices 2025 are in communication with the CPU 2005 through a communication bus (solid lines), such as a motherboard. The storage unit 2015 can be a data storage unit (or data repository) for storing data. The computer system 2001 can be operatively coupled to a computer network (“network”) 2030 with the aid of the communication interface 2020. The network 2030 can be the Internet, an internet and/or extranet, or an intranet and/or extranet that is in communication with the Internet. The network 2030 in some cases is a telecommunication and/or data network. The network 2030 can include one or more computer servers, which can enable distributed computing, such as cloud computing. The network 2030, in some cases with the aid of the computer system 2001, can implement a peer-to-peer network, which may enable devices coupled to the computer system 2001 to behave as a client or a server.

The CPU 2005 can execute a sequence of machine-readable instructions, which can be embodied in a program or software. The instructions may be stored in a memory location, such as the memory 2010. The instructions can be directed to the CPU 2005, which can subsequently program or otherwise configure the CPU 2005 to implement methods of the present disclosure. Examples of operations performed by the CPU 2005 can include fetch, decode, execute, and writeback.

The CPU 2005 can be part of a circuit, such as an integrated circuit. One or more other components of the system 2001 can be included in the circuit. In some cases, the circuit is an application specific integrated circuit (ASIC).

The storage unit 2015 can store files, such as drivers, libraries and saved programs. The storage unit 2015 can store user data, e.g., user preferences and user programs. The computer system 2001 in some cases can include one or more additional data storage units that are external to the computer system 2001, such as located on a remote server that is in communication with the computer system 2001 through an intranet or the Internet.

The computer system 2001 can communicate with one or more remote computer systems through the network 2030. For instance, the computer system 2001 can communicate with a remote computer system of a user. Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 2001 via the network 2030.

Methods as described herein can be implemented by way of machine (e.g., computer processor) executable code stored on an electronic storage location of the computer system 2001, such as, for example, on the memory 2010 or electronic storage unit 2015. The machine executable or machine-readable code can be provided in the form of software. During use, the code can be executed by the processor 2005. In some cases, the code can be retrieved from the storage unit 2015 and stored on the memory 2010 for ready access by the processor 2005. In some situations, the electronic storage unit 2015 can be precluded, and machine-executable instructions are stored on memory 2010.

The code can be pre-compiled and configured for use with a machine having a processer adapted to execute the code or can be compiled during runtime. The code can be supplied in a programming language that can be selected to enable the code to execute in a pre-compiled or as-compiled fashion.

Aspects of the systems and methods provided herein, such as the computer system 2001, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 2001 can include or be in communication with an electronic display 2035 that comprises a user interface (UI) 2040 for providing, for example, designing the CAD model or performing the FEA. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 2005. The algorithm can, for example, perform FEA or calculate the required pressures for obtaining a set dimension (e.g., sagittal height) for a given set of parameters applied to the contact lens

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

### EXAMPLES

### Example 1—Non-Linear Response of a Contact Lens in Response to an Applied Pressure

A contact lens of the present disclosure can comprise a dimension that changes non-linearly as a function of a force or pressure applied to the contact lens, which change in dimension results in a change of optical power of the contact lens. The contact lens may be configured to have the dimension change non-linearly as a function of a pressure applied to the posterior surface.

An example of a dimension of a contact lens of the present disclosure that changes non-linearly as a function of an applied pressure is the sagittal height. As described herein, the pressure sufficient to have the dimension change non-linearly may depend on at least one or more parameters of the contact lens. For example, the parameter may comprise a thickness, a modulus, a diameter of the optical or central portion, and a sagittal height.

To test how each of the operating parameters influence the amount of pressure required to have the sagittal height decrease, a finite element model analysis (FEA) can be performed. In such a model, contact lenses having a variety of physical parameters (central portion diameter, central portion sagittal height (as-fabricated), central portion thickness, and contact lens modulus) are simulated to determine how the dimension (sagittal height) changes as a function of applied pressure.

To generate the model, Computer Aided Design (CAD) is used to model the average eye geometry. The average eye geometry is compiled from a variety of literature references and clinical data. The center of the visual axis is in the top left—this orientation was as if the eye were looking up, which was a convenient orientation for the FEA. The corneal radius is modeled as 7.86 mm, which goes out to a 12 mm diameter. The conjunctival radius is modeled as 12 mm and extends out to a 16 mm diameter which is slightly larger than the contact lenses being tested. There is a limbal junction fillet with a radius of 3 mm. The eye has a uniform thickness of 0.5 mm. The base contact lens geometry has a conforming design (e.g., a first configuration) where the lens matches the eye geometry with a 0.200 mm thickness throughout and a diameter of 14.5 mm (OD). This base contact lens geometry is further refined centrally to provide additional sag (OZ-SAG) which caused a gap between the cornea and the undeformed contact lens. This increased sag occurs over a variable optic zone diameter (OZD).

Using this model, the FEA simulations are performed in Abaqus 2018 using Abaqus/Standard static general procedure type. Due to the symmetries in the system an axisymmetric model is used to improve computational efficiency. The materials are modeled with a linear elastic Young's modulus (E) and Poison's ratio (μ). In the cornea, E=0.5 MPa and μ=0.4. In the lens, E=lens modulus varies with design and μ=0.3. For the mesh, both the eye and lenses are meshed with the same elements and methods: Swept Quad elements, Mesh density=0.05 mm, CAX4R a 4-node linear axisymmetric quadrilateral element with reduced integration and hourglass control. For thin lenses, at least 3 elements are provided through the thickness to improve accuracy in bending.

For the boundary conditions, the posterior surface of the eye is held Encastre (fixed). This provides an opposing force or ‘sink’ so the entire system does not translate. This setup does provide additional stiffness to the eye; however, this model does not include intra-ocular pressure (IOP) which does naturally stiffen the structure. This assumption is expected to be minimal and is supported by the fact that the eye does not go through a global shape change with the application of a contact lens. The axis of revolution (center) for both the eye and lens have an XSYMM (U1=UR2=UR3=0). This is used to enforce the axisymmetric assumption and effectively assure that at the axis of symmetry that a hole does not develop. Without this constraint it would be as if the eye and lens are punctured by an infinitely small needle.

A negative pressure is applied to the posterior surface of the lens ending where the edge rounds anteriorly. This pressure is ramped up linearly throughout the analysis step. For clinical significance, pressure units of millimeters mercury (mmHg) are used. The maximal pressure is varied dependent on the stiffness of the lens being simulated and is again accounted for in the results.

The 2 bodies eye and lens are able to contact each other through a contact pair. The eye is the master surface and lens the slave surface. The slave surface includes the posterior of the lens and the rounded edge. The surface definition uses a finite sliding formulation discretized with a surface to surface method. A coefficient of friction between the bodies is set to 0.9 to minimize slippage of the two stretching the dynamic optic zone. Interference fit gradually removes slave node overclosure during the step with an automatic shrink fit. The interference fit would only be due to the mesh density and is minimal.

The primary analysis output is what posterior suction pressure is required to decrease the sagittal height of the contact lens. Due to the difficulty of measuring the posterior pressure clinically a range of sagittal height values are selected: 0.010 mm, 0.002 mm and 0 mm and the pressure required to obtain such sagittal heights are simulated.

The results show the undeformed lens geometry lay on the eye in a stress-free state only gapping at the center. When pressure is applied the sagittal height is reduced and eventually closes.

Tables 4 and 5 summarize the results of the FEA. In Tables 4 and 5, contact lenses 1-21 and 26-31 are contact lenses that are tested with varying parameters, which may be configured to transition between a first configuration and a second configuration. Contact lenses tested 22-25 represent commercially available contact lenses.

Table 4 shows the pressures (called “Burst Pressure”), calculated from the FEA, necessary for a contact lens with a given set of parameters (diameter, starting sagittal height, modulus, and thickness) to achieve a sagittal height of 0.010 mm, 0.0002 mm and 0 mm.

TABLE 4
Pressures required to obtain particular sagittal heights for a variety of physical parameters.

| | | | | | Burst | Burst | Burst |
|---|---|---|---|---|---|---|---|
| | | | | | Pressure for | Pressure for | Pressure |
| | | | | | 0.010 mm | 0.002 mm | for 0 mm |
| | CP | CP | | CP | sagittal | sagittal | sagittal |
| | Diam | SAG | Modulus | Thick | height | height | height |
| Lens Type | (mm) | (μm) | (MPa) | (μm) | (mmHg) | (mmHg) | (mmHg) |
| 01—Basic | 4 | 50 | 0.5 | 200 | 1.125 | 15.826 | 37.316 |
| 02—Large CP | 5 | 50 | 0.5 | 200 | 0.900 | 9.638 | 29.590 |
| 03—Small CP | 3 | 50 | 0.5 | 200 | 1.838 | 25.840 | 49.617 |
| 04—Large SAG | 4 | 80 | 0.5 | 200 | 4.013 | 34.840 | 59.967 |
| 05—Small SAG | 4 | 30 | 0.5 | 200 | 0.450 | 4.613 | 22.352 |
| 06—Large Modulus | 4 | 50 | 1 | 200 | 2.325 | 25.690 | 51.042 |
| 07—Small Modulus | 4 | 50 | 0.2 | 200 | 0.450 | 7.576 | 22.727 |
| 08—Large CRT | 4 | 50 | 0.5 | 250 | 1.650 | 21.452 | 43.616 |
| 09—Small CRT | 4 | 50 | 0.5 | 150 | 0.750 | 9.938 | 30.453 |
| 10—Largest CP | 7 | 50 | 0.5 | 200 | 0.788 | 4.088 | 20.927 |
| 11—Smallest CP | 2 | 50 | 0.5 | 200 | 6.188 | 47.291 | 72.456 |
| 12—Largest SAG | 4 | 120 | 0.5 | 200 | 13.201 | 65.180 | 72.456 |
| 13—Smallest SAG | 4 | 15 | 0.5 | 200 | 0.113 | 0.600 | 11.101 |
| 14—Largest Modulus | 4 | 50 | 3 | 200 | 6.451 | 48.679 | 78.081 |
| 15—Smallest Modulus | 4 | 50 | 0.1 | 200 | 0.263 | 4.088 | 14.326 |
| 16—Largest CRT | 4 | 50 | 0.5 | 300 | 2.250 | 26.515 | 48.942 |
| 17—Smallest CRT | 4 | 50 | 0.5 | 70 | 0.300 | 1.913 | 16.089 |
| 18—soft CP | 5 | 50 | 0.3 | 150 | 0.413 | 3.300 | 18.564 |
| 19—rigid CP | 3 | 50 | 1 | 250 | 6.151 | 50.404 | 77.856 |
| 20—softest CP | 6 | 50 | 0.2 | 100 | 0.188 | 0.600 | 9.488 |
| 21—extra-rigid CP | 2 | 80 | 2 | 300 | 100.058 | 195.316 | 224.268 |
| 22—RGP 4 | 4 | 50 | 1500 | 120 | 412.834 | 537.344 | 569.147 |
| 23—RGP 6 | 6 | 50 | 1500 | 120 | 351.329 | 468.939 | 500.441 |
| 24—AO | 9 | 0 | 0.7 | 0.7 | 0.430 | 0.435 | 0.436 |
| 25—AO-CND | 9 | 0 | 1.5 | 0.7 | 0.918 | 0.930 | 0.933 |
| 24—18503 | 5 | 100 | 0.35 | 100 | 1.013 | 9.826 | 30.190 |
| 25—18306 | 3 | 100 | 0.35 | 100 | 2.663 | 27.790 | 49.354 |
| 26—722 | 3 | 14 | 0.75 | 200 | 0.225 | 1.538 | 16.576 |
| 27—18405 | 4 | 100 | 0.35 | 100 | 1.425 | 16.576 | 37.953 |
| 28—17515 | 5 | 40 | 0.75 | 200 | 0.863 | 7.726 | 28.577 |
| 29—19501 | 5 | 100 | 0.35 | 200 | 3.038 | 26.402 | 49.129 |
| 30—19601 | 6 | 100 | 0.35 | 200 | 2.138 | 19.914 | 41.141 |
| 31 | 4 | 30 | 0.35 | 130 | 0.188 | 1.238 | 13.764 |

CP = central portion;
Diam = diameter;
SAG = as-fabricated sagittal height;
Thick = thickness;
CRT = central thickness;
RGP = rigid-gas permeable lens;
AO = Acuvue Oasis (Johnson & Johnson);
CND = Ciba Night& Day (Alcon)

TABLE 5
Ratio and statistical analysis of pressures required to obtain particular
sagittal heights for a variety of physical parameters. CP = central
portion; Diam = diameter; SAG = as-fabricated sagittal height;
Thick = thickness; CRT = central thickness; RGP = rigid-gas
permeable lens; AO = Acuvue Oasis (Johnson & Johnson);
CND = Ciba Night& Day (Alcon)

| | Ratio between | | |
|---|---|---|---|
| | Pressure at | | Linear Fit [R] |
| | sagittal height | | *Linear |
| | of 0.01 mm to | | regression |
| | Pressure at | | quantifies |
| | sagittal height | Pearson | goodness of |
| Lens Type | of 0 mm | correlation | fit with R\hat{ }2 |
| 01-Basic | 33.167 | −0.642 | 0.412 |
| 02-Large CP | 32.875 | −0.623 | 0.389 |
| 03-Small CP | 27.000 | −0.643 | 0.414 |
| 04-Large SAG | 14.944 | −0.556 | 0.309 |
| 05-Small SAG | 49.667 | −0.775 | 0.601 |
| 06-Large Modulus | 21.952 | −0.608 | 0.369 |
| 07-Small Modulus | 50.500 | −0.702 | 0.493 |
| 08-Large CRT | 26.432 | −0.639 | 0.408 |
| 09-Small CRT | 40.600 | −0.650 | 0.422 |
| 10-Largest CP | 26.571 | −0.576 | 0.331 |
| 11-Smallest CP | 11.709 | −0.669 | 0.448 |
| 12-Largest SAG | 5.489 | −0.592 | 0.350 |
| 13-Smallest SAG | 98.667 | −0.933 | 0.871 |
| 14-Largest Modulus | 12.105 | −0.707 | 0.500 |
| 15-Smallest Modulus | 54.571 | −0.754 | 0.568 |
| 16-Largest CRT | 21.750 | −0.639 | 0.408 |
| 17-Smallest CRT | 53.625 | −0.651 | 0.424 |
| 18-soft CP | 45.000 | −0.658 | 0.433 |
| 19-rigid CP | 12.659 | −0.745 | 0.556 |
| 20-softest CP | 50.600 | −0.674 | 0.455 |
| 21-extra-rigid CP | 2.241 | −0.813 | 0.660 |
| 22-RGP 4 | 1.379 | −0.993 | 0.987 |
| 23-RGP 6 | 1.424 | −0.990 | 0.980 |
| 24-AO | 1.014 | −0.998 | 0.997 |
| 25-AO-CND | 1.017 | −0.992 | 0.984 |
| 24-18503 | 29.815 | −0.449 | 0.201 |
| 25-18306 | 18.535 | −0.515 | 0.265 |
| 26-722 | 73.667 | −0.908 | 0.824 |
| 27-18405 | 26.632 | −0.486 | 0.236 |
| 28-17515 | 33.130 | −0.655 | 0.429 |
| 29-19501 | 16.173 | −0.509 | 0.259 |
| 30-19601 | 19.246 | −0.481 | 0.231 |
| 31 | 73.400 | −0.837 | 0.700 |

Table 5 shows a table of ratios between the required burst pressure to obtain a sagittal height of 0.01 mm and the required burst pressure to obtain a sagittal height of 0 mm, and the linearity of the fit of the sagittal height as a function of applied pressure. As indicated in Table 5, tested contact lenses 01-21 and 26-31 have a non-linear correlation (where the R²<0.95). In contrast, commercially available contact lenses (contact lenses rows 22-25) exhibit substantially linear correlations.

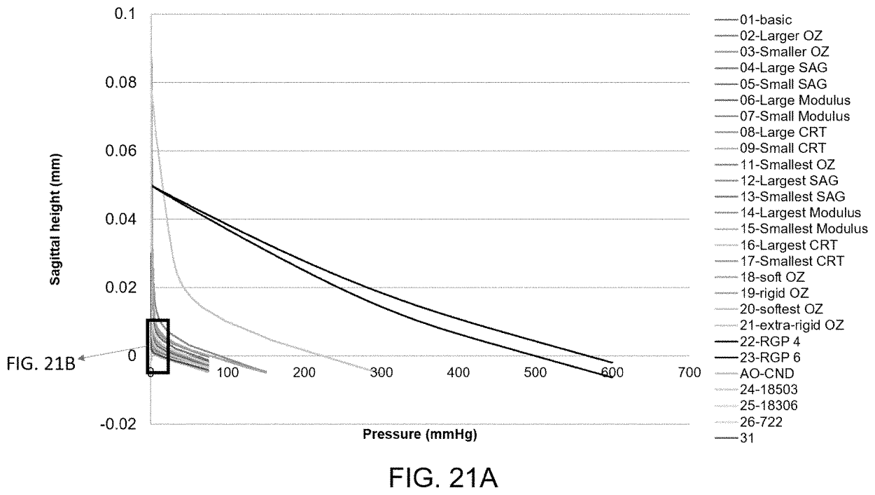

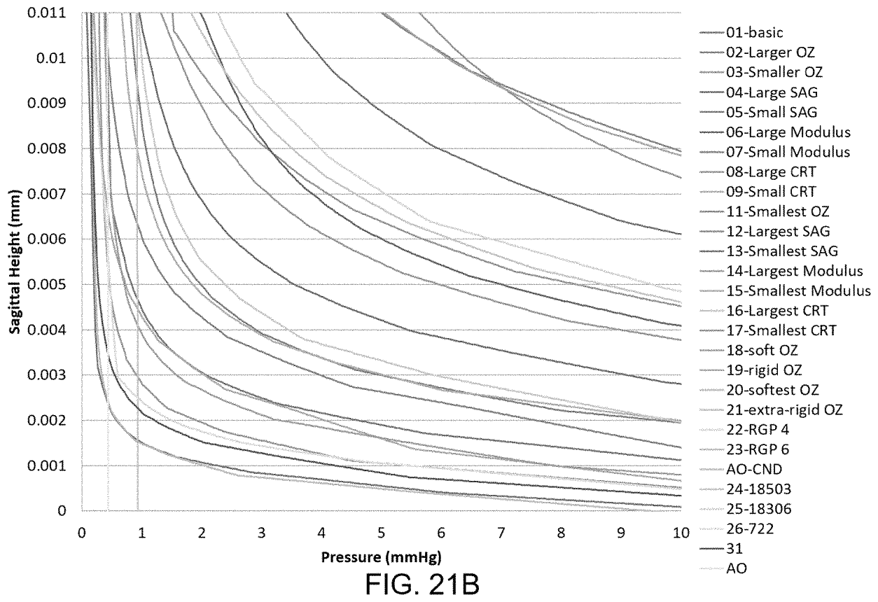

FIGS. 21A-21B show plots of sagittal height of the optical or central portion of the contact lenses tested in the FEA (parameters displayed in Table 4) as a function of applied pressure. Each curve of the plot represents a contact lens with varying parameters tested in the FEA. FIG. 21A shows a plot of the sagittal height as a function of applied pressure, and FIG. 21B shows the same plot with axes adjusted. FIGS. 21A-21B demonstrate that the non-linear change of the sagittal height as a function of applied pressure may be multiphasic or continuous. For example, the non-linear change comprises a non-linear curve having at least two segments. The at least two segments comprises a first steep segment (e.g., when a pressure from about 0 mmHg to about 2 mmHg is applied) where the sagittal height changes in response to the applied pressure at a first rate and a second slight segment where the sagittal height changes in response to the pressure at a second rate less than the first rate (e.g., when a pressure greater than about 20 mmHg is applied).

What is claimed is:

1. A contact lens, comprising:
an anterior surface;
a posterior surface disposed at a dimension from a cornea of a subject when said contact lens is applied to said cornea;
wherein said contact lens is configured to have said dimension change non-linearly as a function of a pressure applied to said posterior surface.

2. The contact lens of claim 1, wherein said posterior surface comprises (i) a central portion comprising a first posterior base curve and (ii) a peripheral portion comprising a second posterior base curve, wherein when said posterior surface is subjected to said pressure, said first posterior base curve is substantially the same as said second posterior base curve.

3. The contact lens of claim 1, wherein, in the absence of said pressure, said first posterior base curve is steeper than said second posterior base curve.

4. The contact lens of claim 2, further comprising, at least one fluid conduit in fluid communication with said anterior surface, an edge of said contact lens, or said peripheral portion of said posterior surface.

5. The contact lens of any one of claim 2, wherein, when applied to said cornea, said first posterior base curve diverges from a curvature of said cornea in the absence of said pressure, and wherein, in the presence of fluid, a tear chamber forms between said cornea and said first posterior base curve.

6. The contact lens of any one of claim 1, wherein said pressure sufficient to have said dimension change non-linearly is based on at least one or more parameters of said contact lens selected from the group consisting of: a thickness, a modulus, a diameter of a central portion of said surface, and a sagittal height.

7. The contact lens of any one of claim 1, wherein said dimension is a sagittal height.

8. The contact lens of any one of claim 1, wherein said dimension is a gap height between said posterior surface and a surface of said cornea.

9. The contact lens of any one of claim 1, wherein said dimension is a difference in curvature between said posterior surface and a surface of said cornea.

10. The contact lens of any one of claim 1, wherein said change in said dimension results in a change in optical power.

11. The contact lens of claim 10, wherein said change in optical power is a decrease in optical power.

12. The contact lens of claim 10, wherein said change in optical power is a flattening of said anterior surface and said posterior surface.

13. The contact lens of claim 1, wherein said anterior surface or said posterior surface changes curvature in response to said pressure in a non-linear manner.

14. The contact lens of claim 10, wherein said change in optical power is an increase in optical power.

15. The contact lens of claim 10, wherein said change in optical power is a bulging of said anterior surface and/or said posterior surface.

16. The contact lens of any one of claim 1, wherein said non-linear change is multiphasic or continuous.

17. The contact lens of any one of claim 1, wherein said non-linear change is defined by a non-linear curve having at least two segments, said at least two segments comprising a first steep segment where said dimension changes in response to said applied pressure at a first rate and a second slight segment where said dimension changes in response to said pressure at a second rate less than said first rate.

18. The contact lens of claim 17, wherein said non-linear curve further comprises at least one additional gradual segment wherein said dimension changes in response to said pressure at a rate between said first and second rates.

19. The contact lens of any one of claim 1, wherein said contact lens comprises silicone, a hydrogel, or a silicone hydrogel.

20. The contact lens of any one of claim 1, wherein said contact lens has a Young's modulus from about 0 mega pascals (MPa) to about 3 MPa.
